(19) United States
(12) Patent Application Publication
(10) Pub. No.: US 2026/0181734 A1
(43) Pub. Date: Jun. 25, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Jing WANG, Beijing (CN)

(73) Assignee: NTT DOCOMO, INC., Tokyo (JP)

(21) Appl. No.: 19/128,638

(22) PCT Filed: Nov. 11, 2022
(86) PCT No.: PCT/JP2022/042071

§ 371 Date: May 9, 2025

(51) Int. Cl. H04W 88/02; H04B 7/06; H04L 5/00

(52) U.S. Cl. CPC H04W 88/02; H04B 7/0626; H04L 5/0051

(57) ABSTRACT

A terminal according to one aspect of the present disclosure includes a receiving section that receives a configuration of a channel state information (CSI) report including a property of a time domain or a Doppler domain, and a control section that determines, based on the configuration, a number of CSI processing units used for processing of the CSI report and a CSI processing unit occupancy time for the processing and that controls the CSI report, based on the number of CSI processing units and the CSI processing unit occupancy time. According to one aspect of the present disclosure, measurement/reporting related to influence on movement can be appropriately performed.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), reporting of channel state information (CSI) based on reference signal reception is under study. Enhancement of communication performance in a terminal (a user terminal, a User Equipment (UE)) that moves/moves at middle speed is under study.

However, measurement/reporting related to influence on movement has not been studied. Unless such a method is defined clearly, communication throughput, communication quality, and the like may deteriorate.

In view of this, the present disclosure has one object to provide a terminal, a radio communication method, and a base station that appropriately perform measurement/reporting related to influence on movement.

### Solution to Problem

A terminal according to one aspect of the present disclosure includes a receiving section that receives a configuration of a channel state information (CSI) report including a property of a time domain or a Doppler domain, and a control section that determines, based on the configuration, a number of CSI processing units used for processing of the CSI report and a CSI processing unit occupancy time for the processing and that controls the CSI report, based on the number of CSI processing units and the CSI processing unit occupancy time.

### Advantageous Effects of Invention

According to one aspect of the present disclosure, measurement/reporting related to influence on movement can be appropriately performed.

### BRIEF DESCRIPTION OF DRAWINGS

FIG. 1 shows an example of a 16-level quantization table.

FIG. 2 shows an example of an 8-level quantization table.

FIGS. 3A and 3B show examples of a Rel-16 type 2 port selection codebook.

FIGS. 4A and 4B show examples of a Rel-17 type 2 port selection codebook.

FIG. 5 shows an example of a parameter combination for a Rel-16 type 2 codebook.

FIG. 6 shows an example of a parameter combination for a Rel-17 type 2 port selection codebook.

FIG. 7 shows an example of a relationship between a CSI-RS resource and a CSI report.

FIG. 8 shows an example of a CSI-RS measurement window and a CSI reporting window.

FIG. 9 shows an example of alternative 2 for a codebook structure.

FIG. 10 shows an example of alternative 3 for a codebook structure.

FIG. 11 shows an example of active duration.

FIG. 12 shows an example of UE operation.

FIG. 13 shows an example of active duration according to Embodiment #3.

FIG. 14 is a diagram to show an example of a schematic structure of a radio communication system according to one embodiment.

FIG. 15 is a diagram to show an example of a structure of a base station according to one embodiment.

FIG. 16 is a diagram to show an example of a structure of a user terminal according to one embodiment.

FIG. 17 is a diagram to show an example of a hardware structure of the base station and the user terminal according to one embodiment.

FIG. 18 is a diagram to show an example of a vehicle according to one embodiment.

### DESCRIPTION OF EMBODIMENTS

### (CSI Report (or Reporting))

In Rel-15 NR, a terminal (also referred to as a user terminal, a User Equipment (UE), and the like) generates (also referred to as determines, calculates, estimates, measures, and the like) channel state information (CSI), based on a reference signal (RS) (or a resource for the RS), and transmits (also referred to as reports, feeds back, and the like) the generated CSI to a network (for example, a base station). The CSI may be transmitted to the base station by using an uplink control channel (for example, a Physical Uplink Control Channel (PUCCH)) or an uplink shared channel (for example, Physical Uplink Shared Channel (PUSCH)), for example.

The RS used for the generation of the CSI may be at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like, for example.

The CSI-RS may include at least one of a non-zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The UE may receive information related to a CSI report (report configuration information), and may control, based on the report configuration information, CSI reporting. The report configuration information may be, for example, an information element (IE) “CSI-ReportConfig” of radio resource control (RRC). Note that, in the present disclosure, the RRC IE may be interchangeably interpreted as an RRC parameter, a higher layer parameter, and the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent (semi-permanent) CSI (SP-CSI) report.

The report quantity information may indicate at least one combination of the above CSI parameters (for example, CRI, RI, PMI, COI, LI, L1-RSRP, and the like).

The resource information may be an ID of the resource for the RS. The resource for the RS may include, for example, a non-zero power CSI-RS resource or SSB, and a CSI-IM resource (for example, a zero power CSI-RS resource).

The frequency domain information may indicate frequency granularity of the CSI report. The frequency granularity may include, for example, a wideband and a subband. The wideband is the entire CSI reporting band. For example, the wideband may be the entire certain carrier (component carrier (CC), cell, serving cell), or may be the entire bandwidth part (BWP) in a certain carrier. The wideband may be interpreted as CSI reporting band, the entire CSI reporting band, and the like.

The subband may be part of the wideband and constituted of one or more resource blocks (RBs or physical resource blocks (PRBs)). The size of the subband may be determined according to the size of the BWP (the number of PRBs).

The frequency domain information may indicate a PMI of which of the wideband or the subband is to be reported (frequency domain information may include, for example, an RRC IE “pmi-FormatIndicator” used for determination of one of wideband PMI reporting and subband PMI reporting). The UE may determine, based on at least one of the report quantity information and the frequency domain information, frequency granularity of the CSI report (that is, one of the wideband PMI report or the subband PMI report).

When the wideband PMI report is configured (determined), one wideband PMI may be reported for the entire CSI reporting band. On the other hand, when the subband PMI report is configured, single wideband indication i₁ may be reported for the entire CSI reporting band, and subband indication (one subband indication) i₂ for each of one or more subbands in the entire CSI reporting (for example, subband indication for each subband) may be reported.

The UE performs channel estimation by using a received RS to estimate a channel matrix H. The UE feeds back an index (PMI) determined based on the estimated channel matrix.

The PMI may indicate a precoder matrix (also simply referred to as a precoder) that the UE considers appropriate for the use for downlink (DL) transmission to the UE. Each value of the PMI may correspond to one precoder matrix. A set of values of the PMI may correspond to a different set of precoder matrices referred to as a precoder codebook (also simply referred to as a codebook).

In the spatial domain (space domain), the CSI report may include CSI of one or more types. For example, the CSI may include at least one of a first type (type 1 CSI) used for selection of a single beam, and a second type (type 2 CSI) used for selection of multi-beam. The single beam may be interpreted as a single layer, and the multi-beam may be interpreted as a plurality of beams. The type 1 CSI may not assume multi-user multiple input multiple output (MU-MIMO), and the type 2 CSI may assume multi-user MIMO.

The above codebook may include a codebook for the type 1 CSI (also referred to as a type 1 codebook or the like) and a codebook for the type 2 CSI (also referred to as a type 2 codebook or the like). The type 1 CSI may include type 1 single-panel CSI and type 1 multi-panel CSI, and different codebooks (type 1 single-panel codebook, type 1 multi-panel codebook) may be defined.

In the present disclosure, Type 1 and Type I may be interchangeably interpreted. In the present disclosure, Type 2 and Type II may be interchangeably interpreted.

An uplink control information (UCI) type may include at least one of a Hybrid Automatic Repeat reQuest ACKnowledgement (HARQ-ACK), a scheduling request (SR), and CSI. UCI may be delivered on a PUCCH, or may be delivered on a PUSCH.

In Rel-15 NR, the UCI can include one CSI part for wideband PMI feedback. CSI report #n includes, if reported, PMI wideband information.

In Rel-15 NR, the UCI can include two CSI parts for subband PMI feedback. CSI part 1 includes wideband PMI information. CSI part 2 includes one piece of wideband PMI information and some pieces of subband PMI information. CSI part 1 and CSI part 2 are separately coded.

In Rel-15 NR, the UE is configured with N (N≥1) report settings for CSI report configuration and M (M≥1) resource settings for CSI resource configuration, by a higher layer. For example, the CSI report configuration (CSI-ReportConfig) includes a resource setting for channel measurement (resources ForChannelMeasurement), a CSI-IM resource setting for interference (csi-IM-ResourceForInterference), an NZP-CSI-RS setting for interference (nzp-CSI-RS-ResourceForInterference), a report quantity (reportQuantity), and the like. Each of the resource setting for channel measurement, the CSI-IM resource setting for interference, and the NZP-CSI-RS setting for interference is associated with a CSI resource configuration (CSI-ResourceConfig, CSI-ResourceConfigId). The CSI resource configuration includes a list of CSI-RS resource sets (csi-RS-ResourceSetList, for example, NZP-CSI-RS resource set or CSI-IM resource set).

For enabling, for both of FR1 and FR2, more dynamic channel/interference hypotheses for NCJT, assessment and specifications of CSI reporting for DL transmission with at least one of multi-TRP and multi-panel are under study.

### (Codebook Configuration)

The UE is configured with a codebook-related parameter (codebook configuration (CodebookConfig)) by higher layer signaling (RRC signaling). The codebook configuration is included in a CSI report configuration (CSI-ReportConfig) of a higher layer (RRC) parameter.

In the codebook configuration, at least one codebook of a plurality of codebooks including a type 1 single panel (typeI-SinglePanel), type 1 multi-panel (typeI-MultiPanel), type 2 (typeII), and type 2 port selection (typeII-PortSelection) is selected.

The codebook parameter includes a parameter related to codebook subset restriction (CBSR) ( . . . Restriction). Configuration of the CBSR is a bit indicating, for a precoder associated with a CBSR bit, which PMI report is allowed (“1”) and which PMI report is not allowed (“0”). 1 bit of a CBSR bitmap corresponds to one codebook index/antenna port.

### (CSI Report Configuration)

CSI report configuration (CSI-ReportConfig) of Rel. 16 includes CSI-RS resources for channel measurement (resources ForChannelMeasurement (CMRs)), CSI-RS resources for interference measurement (csi-IM-ResourcesForInterference (ZP-IMRs), nzp-CSI-RS-ResourcesFor Interference (NZP-IMRs)), and the like, in addition to a codebook configuration (CodebookConfig). The parameters of CSI-ReportConfig excluding codebookConfig-r16 are also included in CSI report configuration of Rel. 15.

For Rel. 17, enhanced CSI report configuration (CSI-ReportConfig) for multi-TRP CSI measurement/reporting using NCJT is under study. In the CSI report configuration, two CMR groups corresponding to two respective TRPs are configured. CMRs in the CMR groups may be used for measurement of at least one of multi-TRP using NCJT and a single TRP. N CMR pairs for NCJT are configured by RRC signaling. Whether CMRs of a CMR pair are to be used for single TRP measurement may be configured for the UE by RRC signaling.

For CSI reporting associated with multi-TRP/panel NCJT measurement and configured by a single CSI report configuration, support of at least one of Options 1 and 2 below is under study.

### <Option 1>

The UE is configured to report X (X=0, 1, 2) pieces of CSI associated with single TRP measurement hypotheses and one piece of CSI associated with NCJT measurement. When X=2, two pieces of CSI are associated with two different single TRP measurements using CMRs of different CMR groups.

### <Option 2>

The UE may be configured to report one piece of CSI associated with the best measurement result of measurement hypotheses for NCJT and a single TRP.

As described above, in Rel. 15/16, CBSR is configured for each codebook configuration for each CSI report configuration. In other words, the CBSR is applied to all the CMRs and the like in corresponding CSI reporting configuration.

Note, however, that there is a possibility that when the Options 1 and 2 above are applied to multi-TRP CSI report configuration of Rel. 17 by CSI report configuration, configuration of the following measurement is performed.
Option 1 (X=0): measurement of only CSI for NCJT
Option 1 (X=1): measurement of CSI for NCJT and CSI for single TRP (one TRP)
Option 1 (X=2): measurement of CSI for NCJT and CSI for single TRP (two TRPs)
Option 2: measurement of both of CSI for NCJT and CSI for single TRP

### (Type 1 Codebook)

As a type 1 codebook (Rel. 15), a type 1 single-panel codebook and a type 1 multi-panel codebook are defined for a base station panel. In a type 1 single panel, an antenna model of a CSI antenna port array (logical configuration) is defined for (N1, N2). The number P_{CSI-RS} of CSI-RS antenna ports is 2N₁N₂. In type 1 multi-panel, an antenna model of a CSI antenna port array (logical configuration) is defined for the number P_{CSI-RS} of CSI-RS antenna ports and (N_{g}, N₁, N₂).

For Rel-15 type 1 single-panel CSI, a higher layer parameter of a codebook type (subType in type1 in codebookType in CodebookConfig) is set to a type 1 single panel (‘typeI-SinglePanel’) for the UE. The number v of layers∈{2, 3, 4} is not satisfied, PMI values correspond to three codebook indices i_{1,1}, i_{1,2}, i₂. The number v of layers∈{2, 3, 4} is satisfied, PMI values correspond to four codebook indices i_{1,1}, i_{1,2}, i_{1,3}, i₂. The number v of layers∈{2, 3, 4} is not satisfied, composite codebook index i₁=[i_{1,1}, i_{1,2}]. The number v of layers∈{2, 3, 4} is satisfied, composite codebook index i₁=[i_{1,1}, i_{1,2}, i_{1,3}]. i₁ may be an index for a wide band. i₂=n may be an index for a subband/phase.

For P_{CSI-RS}, supported configurations (value combinations) of (N₁, N₂) and (O₁, O₂) are defined in a specification. (N₁, N₂) indicates the number of two-dimensional (2D) antenna elements, and is configured by a higher layer parameter “n1-n2” in moreThanTwo in nrOfAntennaPorts in typeI-SinglePanel. “n1-n2” is a N₁O₁N₂O₂-bit bitmap parameter. (O₁, O₂) is a 2D oversampling factor.

In a codebook for 1-layer CSI reporting and codebookMode=1, index i_{1,1} corresponding to a horizontal beam=1=0, 1, . . . , N₁O₁−1, i_{1,2} corresponding to a vertical beam=m=0, 1, . . . , N₂O₂−1, i₂=n=, 0, 1, 2, 3, and a matrix for the 1-layer CSI reporting codebook using antenna ports 3000 to 2999+P_{CSI-RS} is W_i_{1,1},i_{1,2},i₂\hat{ }(1). Here, W_{1,m,n}⁽¹⁾ is given by the following equation.

$${W}_{l , m , n}^{( 1 )} = \frac{1}{\sqrt{{P}_{CRI - RS}}} [ \begin{matrix}{v}_{l , m} \\ {φ}_{n} {v}_{l , m}\end{matrix} ] \qquad ( X1 )$$

Here, v_{1,m} is a 2D-SD-DFT base having N₁ rows and N₂ columns (exp(j2π1n₁/O₁N₁)×exp(j2πmn₂/O₂N₂), n₁=0, 1, . . . , N₁−1, n₂=0, 1, . . . , N₂−1). Co-phasing between polarizations (horizontal polarization and vertical polarization) φₙ=exp(jπn/2), and indicates a phase of one polarization relative to a phase of the other polarization.

For Rel-15 type 1 multi-panel CSI, as compared with that for the type 1 single panel, the number N_{g} of panels is configured in addition to N₁, N₂. As inter-panel co-phasing (phase compensation between panels), i,_{1,4} is additionally reported. The same SD beam (precoding matrix W₁) is selected for each panel, and only inter-panel co-phasing is additionally reported.

For P_{CSI-RS}, supported configurations (value combinations) of (N_{g}, N₁, N₂) and (O₁, O₂) are defined in a specification. (N₁, N₂) is configured by ng−n1−n2 in typeI-MultiPanel. i_{1,1} is {0, 1, . . . , N₁O₁−1}. i_{1,2} is {0, 1, . . . , N₂O₂−1}. For q=1, . . . , N_{g}−1, i_{1,4,q} is {0, 1, 2, 3}. i₂ is {0, 1, 2, 3}. For codebookMode=1, a matrix for a 1-layer CSI report codebook using antenna ports 3000 to 2999+P_{CSI-RS} is W_i_{1,1}, i_{1,2}, i_{1,4}, i₂\hat{ }(1). Here, W_{l,m,p,n}⁽¹⁾=W_{l,m,p,n}\hat{ }1, N_{g}, 1.

W_l,m,p,n\hat{ }1,N_{g},1 and W_l,m,p,n\hat{ }2,N_{g},1 for N_{g}={2, 4} (matrix W_{l,m,p,n}^{1,2,1} for the first layer, N_{g}=2, codeBookMode=1, matrix W_{l,m,p,n}^{2,2,1} for the second layer, N_{g}=2, codeBookMode=1, matrix, W_{l,m,p,n}^{1,4,1} for the first layer, N_{g}=4, codeBookMode=1, and matrix W_{l,m,p,n}^{2,4,1} for the second layer, N_{g}=4, codeBookMode=1) are given by the following equations.

$${W}_{l , m , p , n}^{1 , 2 , 1} = \frac{1}{\sqrt{{P}_{CRI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ] \qquad ( X2 )$$

$${W}_{l , m , p , n}^{2 , 2 , 1} = \frac{1}{\sqrt{{P}_{CRI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m}\end{matrix} ]$$

$${W}_{l , m , p , n}^{1 , 4 , 1} = \frac{1}{\sqrt{{P}_{CRI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ]$$

$${W}_{l , m , p , n}^{2 , 4 , 1} = \frac{1}{\sqrt{{P}_{CRI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m} \\ {φ}_{{p}_{2}} {v}_{l , m} \\ - {φ}_{n} {φ}_{{p}_{2}} {v}_{l , m} \\ {φ}_{{p}_{3}} {v}_{l , m} \\ - {φ}_{n} {φ}_{{p}_{3}} {v}_{l , m}\end{matrix} ]$$

Here, φₙ=e^{jπn/2}. For N_{g}=2, p=p₁, and for N_{g}=4, p=[p₁, p₂, p₃]. φ_p₁, φ_p₂, and φ_p₃ indicate inter-panel co-phasing. The same beam (SD beam matrix, precoding matrix W₁) is selected for panels 0, 1, 2, and 3, and φ_p₁, φ_p₂, and φ_p₃ indicate phase compensation for panel 1, phase compensation for panel 2, and phase compensation for panel 3 relative to panel 0, respectively.

### (Type 2 Codebook)

In the present disclosure, matrix Z with X rows and Y columns is sometimes expressed as Z(X×Y).

For type 2 CSI of Rel. 15, generation of per-subband (SB-wise) precoding vectors is based on the following equation for given layer l.

$${W}_{l} ( {N}_{t} \times {N}_{3} ) = {W}_{1} {W}_{2 , l} \qquad ( X3 )$$

Nₜ is the number of antennas/antenna ports. N₃ is a total number of precoding (beamforming) matrices (precoders) (number of subbands) indicated by a PMI. W₁ (Nₜ×2L) is a matrix (SD beam matrix) formed by L∈{2, 4} (oversampled) spatial domain (SD) 2D DFT vectors (SD beams, 2D-DFT vectors). L is the number of beams. The actual number of beams taking account of a horizontal polarization and a vertical polarization at one point is 2L. For example, L=2 SD 2D-DFT vectors are bᵢ and bⱼ. W_{2,1}(2L×N₃) is a matrix (LC coefficient matrix) formed by linear combination (LC) coefficients (subband complex LC coefficients, combination coefficients) for layer l. W_{2,1} indicates beam selection and co-phasing between two polarizations. For example, two W_{2,1} are cᵢ and cⱼ. For example, channel vector h is approximated by linear combination of L=2 SD 2D-DFT vectors cᵢbᵢ, +cⱼbⱼ. Feedback overhead is primarily caused by LC coefficient matrix W_{2,1}. The type 2 CSI of Rel. 15 supports only ranks 1 and 2.

In the type 2 CSI, a channel (channel matrix) for a certain user is indicated by two polarizations and linear combination of L beams (L 2D-DFT vectors). The type 2 CSI of Rel. 15 supports ranks 1 and 2.

### (Enhancement of Type 2 Codebook)

Type 2 CSI of Rel. 16 (enhanced type 2 codebook) reduces overhead related to W_{2,1} by using frequency domain (FD) compression. The type 2 CSI of Rel. 16 supports ranks 3 and 4 in addition to ranks 1 and 2.

In the type 2 CSI of Rel. 16, information based on the following equation is reported by the UE for given layer l.

$${W}_{l} = {W}_{1} {W}_{l}^{∼} {W}_{f , l}^{H} \qquad ( X4 )$$

W_{2,1} is approximated by W\tilde{ }ₗW_{f,l}^{H}. Matrix W\tilde{ } may be expressed by adding ˜ to the top of W (tilde on w). W\tilde{ }ₗ may be expressed as W\tilde{ }_{2,l}. Matrix W_{f,l}^{H} is an adjoint matrix of W_{f,l}, and is obtained by conjugate transposition of W_{f,l}.

For a CSI report, the UE may be configured with one of two subband sizes. The subband (CQI subband) may be defined as N_{PRB}^{SB} consecutive PRBs, and may depend on a total number of PRBs in a BWP. The number R of PMI subbands per COI subband is configured by an RRC IE (numberOfPMI-SubbandsPerCQI-Subband). R controls a total number N₃ of precoding matrices indicated by a PMI, as a function of the number of subbands configured in csi-ReportingBand, a subband size configured by subbandSize, and a total number of PRBs in a BWP.

W₁ (Nₜ×2L) is a matrix formed by a plurality of (oversampled) spatial domain (SD) 2D-DFT (vectors, beams). For this matrix, a plurality of indices of two-dimensional discrete Fourier transform (2D-DFT) vectors and a two-dimensional over-sampling factor are reported. Response/distribution of a spatial domain indicated by an SD 2D-DFT vector may be referred to as an SD beam.

W\tilde{ }ₗ(2L×Mᵥ) is a matrix formed by an LC coefficient. For this matrix, up to K₀ non-zero coefficients (NZCs, non-zero amplitude LC coefficients) are reported. The report is formed by two parts: a bitmap for identifying an NZC location, and a quantized NZC.

W_{f,l}(N₃×Mᵥ) is a matrix formed by a plurality of frequency domain (FD) bases (vectors) for layer l. N₃ is a total number of precoding (beamforming) matrices (precoders) (number of subbands) indicated by a PMI, as a function of the number of subbands configured in csi-ReportingBand. csi-ReportingBand indicates consecutive or non-consecutive subbands in a certain BWP in a case where CSI for the BWP is reported. Mᵥ FD bases (FD DFT bases) are present for each layer. When N₃>19, Mᵥ DFTs from an intermediate subset (InS) of size N₃′ (<N₃) are selected. When N₃≤19, log₂(C(N₃−1, Mᵥ−1)) bits are reported. Here, C(N₃−1, Mᵥ−1) indicates the number of combinations to select Mᵥ−1 from N₃−1 (combinatorial coefficient C(x, y)), and is also referred to as binomial coefficients.

Response/distribution (frequency response) of a frequency domain indicated by an FD base vector and linear combination of LC coefficients may be referred to as an FD beam. The FD beam may correspond to a delay profile (time response).

A PMI subband size is given by a COI subband size/R, and R ∈{1, 2}. The number Mᵥ of FD bases for given rank v is given by ceil(pᵥ×N₃/R). The number of FD bases is the same for all the layers l∈{1, 2, 3, 4}. pᵥ is configured by a higher layer.

An FD base (DFT) for index t=0, 1, . . . , N₃−1 associated with the precoding matrix (subband) and for layer l=1, . . . , v is y_{t,l}^{(f)}=exp(j2πtn_{3,l}^{(f)}/N₃). In Mᵥ FD base vectors, an FD base vector for index f=0, 1, . . . , Mᵥ−1 associated with the FD base vector is [y_{0,l}^{(f)}, y_{1,l}^{(f)}, . . . , y_{N_3-1,l}^{(f)}]^{T}. The Mᵥ FD base vectors are identified by Mᵢₙᵢₜᵢₐₗ∈{−2Mᵥ+1, −2Mᵥ+2, . . . , 0}, n_{3,1}=[n_{3,l}⁽⁰⁾, . . . , n_{3,l}^{(M_v-1)}], and n_{3,l}^{(f)}∈{0, 1, . . . , N₃−1}.

Each row of matrix W_{2,l} indicates channel frequency response of a specific SD beam. When the SD beam has high directivity, a channel tap per beam is limited (power delay profile becomes sparse in the time domain). As a result, channel frequency response for each SD beam has high correlation (becomes close to a flat form in the frequency domain). In this case, the channel frequency response can be approximated by linear combination of a small number of FD bases. For example, when Mᵥ=2, by using FD bases f₂, f_{q} and LC coefficients d₁⁰, d₂⁰, frequency response associated with SD beam b₀ is approximated by d₁⁰f₂+, d₂⁰f_{q}.

Mᵥ dominant FD bases are selected. With Mᵥ<<N₃, overhead of W˜ₗ is much smaller than overhead of W_{2,l}. All or some of the Mᵥ FD bases are used to approximate frequency response of each SD beam. A bitmap is used to report only an FD base selected for each SD beam. If no bitmap is reported, all the FD bases are selected for each SD beam. In this case, NZCs of all the FD bases are reported for each SD beam. The number of NZCs in one layer Kₗ^{NZ}≤K₀=ceil(β×2LMᵥ), and the number of NZCs over all the layers K^{NZ}≤2K₀=ceil(β×2LMᵥ). β is configured by a higher layer.

In the Rel-16 (enhanced) type 2 codebook, values of L, β, and pᵥ (parameter combination) are determined by a higher layer parameter “paramCombination-r16” (codebook parameter configuration).

Type 2 CSI feedback on a PUSCH in Rel. 16 includes two parts. CSI part 1 has a fixed payload size, and is used to identify the number of information bits in CSI part 2. A size of part 2 is variable (UCI size depends on the number of NZCs that is not recognized by the base station). In CSI part 1, the UE reports the number of NZCs that determines the size of CSI part 2. After receiving CSI part 1, the base station recognizes the size of CSI part 2.

In enhanced type 2 CSI feedback, CSI part 1 includes an RI, a CQI, and an indication of a total number of non-zero amplitudes (NZCs) over a plurality of layers for enhanced type 2 CSI. Fields of Part 1 are separately coded. CSI part 2 includes a PMI of enhanced type 2 CSI. Parts 1 and 2 are separately coded. CSI part 2 (PMI) includes at least one of an oversampling factor, an index of a 2D-DFT base, an index Mᵢₙᵢₜᵢₐₗ of an initial DFT base (start offset) of a selected DFT window, a DFT base selected for each layer, an NZC (amplitude and phase) per layer, a strongest (maximum strength, maximum amplitude) coefficient indicator (SCI) per layer, and amplitude of the strongest coefficient per layer/per polarization.

A plurality of PMI indices (PMI values, codebook indices) associated with different pieces of CSI part 2 information may follow the following for the l-th layer.
i_{1,1}: two-dimensional oversampling factor [q1, q2] q₁ ∈{0, 1, . . . , O₁−1}, q2 ∈{0, 1, . . . , O₂−1}.
i_{1,2}: plurality of indices of (SD) 2D-DFT bases (beams) i_{1,2}∈{0, 1, . . . , C(N₁N₂, L)−1}.
i_{1,5}: codebook indicator. An index of a (FD) DFT base of the selected DET window. i_{1,5} ∈{0, 1, . . . , 2Mᵥ−1}.
i_{1,6,l}: codebook indicator A (FD) DFT base selected for the l-th layer. When N₃≤19, i_{1,6,l}∈{0, 1, . . . , C(N₃−1, Mᵥ−1)−1}. When N₃>19, i_{1,6,l}∈{0, 1, . . . , C(2Mᵥ−1, Mᵥ−1)−1}.
i_{1,7,l}: bitmap indicator for l-th layer A non-zero bit in the bitmap identifies which coefficient of i_{2,4,l} and i_{2,5,l} is reported.

$${i}_{1 , 7 , 1} = [ {k}_{l , 0}^{( 3 )} … {k}_{l , Mv - 1}^{( 3 )} ] , {k}_{l , f}^{( 3 )} = [ {k}_{l , 0 , f}^{( 3 )} … {k}_{l , M \_ v - 1 , f}^{( 3 )} ] , and {k}_{l , i , f}^{( 3 )} ∈ \{ 0 , 1 \} .$$

i_{1,8,l}: strongest coefficient indicator for l-th layer (maximum element k_{l,i,f}⁽²⁾ in amplitude coefficient indicator)
i_{2,3,l}: amplitude coefficient indicator of coefficient (wide band) for l-th layer (for both polarizations) i_{2,3,l}=[k_{l,0}⁽¹⁾ k_{l,1}⁽¹⁾].
i_{2,4,l}: amplitude coefficient indicator of reported coefficient (subband) for l-th layer i_{2,3,l}=[k_{l,0}⁽²⁾ . . . k_{l,Mv-1}⁽²⁾].
i_{2,5,l}: phase coefficient indicator of reported coefficient (subband) for l-th layer i_{2,5,l}=[c_{l,0,f} . . . c_{l,Mv-1,f}].

Assume that fₗ*∈{0, 1, . . . , Mᵥ−1} and iₗ*∈{0, 1, . . . , 2L−1} are an index of i_{2,4,l} and an index of k_{l,f_l\hat{ }*}⁽²⁾, respectively. These fₗ* and iₗ* identify the strongest coefficient for layer l=1, . . . , v, that is, an element k_{l,i_l\hat{ }*,f_l\hat{ }*}⁽²⁾ of i_{2,4,l} for layer l. A codebook index n_{3,l} is remapped as n_{3,l}^{(f)}=(n_{3,l}^{(f)}−n_{3,l}^{(f_l\hat{ }*)}) mod N₃, for n_{3,l}^{(f_l\hat{ }*)}, and, after the remapping, n_{3,l}^{(f_l\hat{ }*)}=0. An index f is remapped as f=(f−fₗ*) mod Mv, for fₗ*, and, after the remapping, fₗ*=0 (l=1, . . . , v). i_{2,4,l}, i_{2,5,l}, and i_{1,7,l} indicate an amplitude coefficient, a phase coefficient, and a bitmap after the remappings, respectively. The strongest coefficient for layer l identified by i_{1,8,l}∈{0, 1, . . . , 2L−1} is given as i_{1,8,l}=Σᵢ₌₀^{i_l\hat{ }*}k_{l,i,0}⁽³⁾−1 and i_{1,8,l}=iₗ* for v=1 and 1<v≤4, respectively.

Each reported LC coefficient (complex coefficient) in W\tilde{ }ₗ is separately quantized amplitude and phase.

### {Amplitude Quantization}

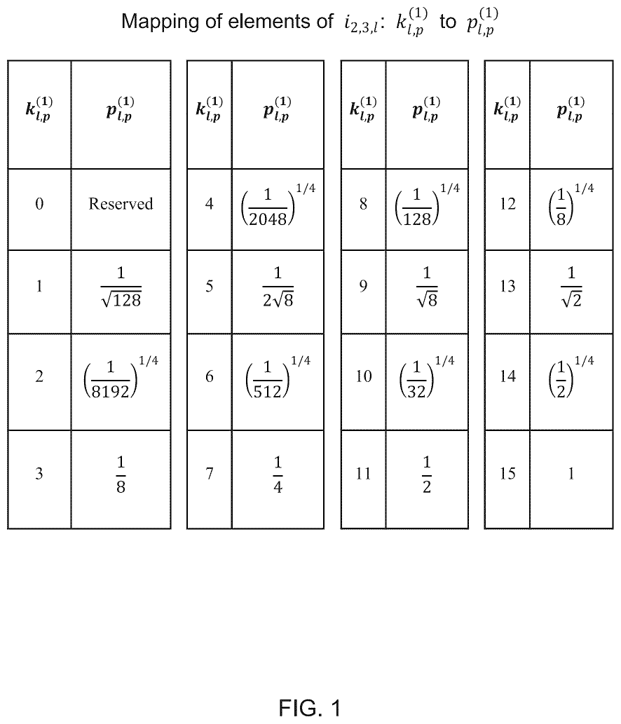

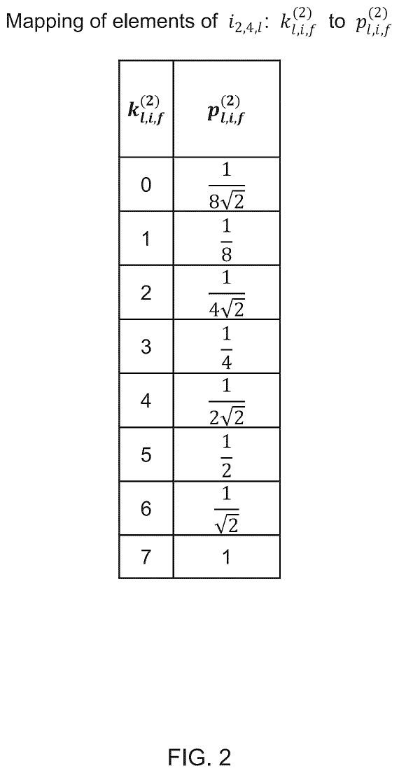

Polarization-specific reference amplitude is 16-level quantization using a table of FIG. 1 (mapping of elements in amplitude coefficient indicator i_{2,3,l}: mapping from amplitude coefficient indicator element k_{l,p}⁽¹⁾ to amplitude coefficient p_{l,p}⁽¹⁾. This table quantizes p₁⁽¹⁾=[p_{l, 0}⁽¹⁾ p_{l,1}⁽¹⁾] to [k_{l,0}⁽¹⁾ k_{l,1}⁽¹⁾], k_{l,p}⁽¹⁾∈{0, . . . , 15}. All the other coefficients are 8-level quantization using a table of FIG. 2 (mapping of elements in amplitude coefficient indicator i_{2,4,l}: mapping from amplitude coefficient indicator element k_{l,i,f}⁽²⁾ to amplitude coefficient p_{l,i,f}⁽²⁾). This table quantizes p₁⁽²⁾=[p_{1,0}⁽²⁾ . . . p_{1,Mv-1}⁽²⁾] and p_{l,f}⁽²⁾=[p_{l,0,f}⁽²⁾ . . . p_{l,2L-1·f}⁽²⁾] to k_{l,f}⁽²⁾=[k_{l,0,f}⁽²⁾ . . . . k_{l,2L-1·f}⁽²⁾] and k_{l,i,f}⁽²⁾∈{0, . . . , 7}.

### {Phase Quantization}

Elements (amplitude coefficient indicator elements) [c_{l,0} . . . . c_{l, Mv-1}] in amplitude coefficient indicator i_{2,5,l} are reported by the UE (by using 4 bits). All the phase coefficients are quantized by using 16-PSK. Phase coefficient with quantity for co-phasing φ_{l,i,f}=exp(j2πc_{l,i,f}/16) is quantized to c_{l,f}=[c_{l,0,f} . . . c_{l,2L-1·f}], c_{l,i,fi}∈{0, . . . , 15}.

Amplitude coefficient indicator element k_{l,floor(i_l\hat{ }*/L)}⁽¹⁾, amplitude coefficient indicator element k_{l,i_1\hat{ }*,0}⁽²⁾, and phase coefficient indicator element c_{l,i_1\hat{ }*,0}⁽²⁾ corresponding to the strongest coefficient for layer l=15 (maximum value), 7 (maximum value), and 0 (minimum value), respectively. For l=1, . . . , v, k_{l,floor(i_l\hat{ }*/L)}⁽¹⁾, k_{l,i_l\hat{ }*,0}⁽²⁾, and c_{l,i_l\hat{ }*,0}⁽²⁾=0 are not reported.

i_{1,5} and i_{1,6,l} are PMI indices for (FD) DFT base reporting. i_{1,5} is reported only when N₃>19.

Matrix W^{(v)} indicated by a codebook for v (=1 to 4)-layer CSI reporting using 3000 to 2999+P_{CSI-RS} is based on matrix W¹ below for layer l (=1 to v).

$${W}_{{q}_{1} , {q}_{2} , {n}_{1} , {n}_{2} , {n}_{3 , l} , {p}_{l}^{( 1 )} , {p}_{l}^{( 2 )} , {i}_{\text{?}} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i , f}^{( 2 )} {φ}_{l , i + L , f}\end{matrix} ] , l = 1 , 2 , 3 , 4 , \qquad ( Y1 )$$

$${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$$

$$\text{?} \text{indicates text missing or illegible when filed}$$

Here, beam index i=0, 1, . . . , L−1, m₁⁽ⁱ⁾=0₁n₁(i)+q₁, m₂⁽ⁱ⁾=O₂n₂⁽ⁱ⁾+q₂, n₁⁽ⁱ⁾ ∈{0, 1, . . . , Nₗ−1}, and n₂⁽ⁱ⁾∈{0, 1, . . . , N₂−1}. V_{m_1\hat{ }(i), m_2\hat{ }(i)}, p_{l,0}⁽¹⁾ and p_{l,i,f}⁽²⁾, and φ_{l,i,f} indicate an SD (beam)-DFT base, an amplitude coefficient, and a phase coefficient, respectively. Thus, a codebook for each layer includes the strongest coefficient per polarization, an amplitude coefficient per polarization, per FD-DFT base, and per SD-DET base, and a phase coefficient per polarization, per FD-DFT base, and per SD-DFT base.

As grouping of CSI parts 2, for a given CSI report, PMI information is grouped into three groups (groups 0 to 2). This is important for a case where CSI omission is performed. Each reported element of indices i_{2,4,l}, i_{2,5,l}, and i_{1,7,l} is associated with a specific priority rule. Groups 0 to 2 follow the following.
Group 0: indices i_{1,1}, i_{1,2} and i_{1,8,l} (l=1, . . . , v)
Group 1: highest (higher) v2LMᵥ-floor (K^{NZ}/2) priority elements in index i_{1,5} (if reported) and indices i_{1,6,l} and i_{1,7,l} (if reported), highest (higher) ceil(K^{NZ}/2)−v priority elements in i_{2,3,l} and i_{2,4,l}, and highest (higher) ceil(K^{NZ}/2)−v priority elements in i_{2,5,l} (l=1, . . . , v)
Group 2: lowest (lower) floor (K^{NZ}/2) priority elements in i_{1,7,l}, lowest (lower) floor (K^{NZ}/2) priority elements in i_{2,4,l}, and lowest (lower) floor (K^{NZ}/2) priority elements in i_{2,5,l} (l=1, . . . , v)

In type 1 CSI, an SD beam indicated by an SD DFT vector is transmitted to the UE. In type 2 CSI, L SD beams are linearly coupled and transmitted to the UE. Each SD beam can be associated with a plurality of FD beams. For corresponding SD beams, channel frequency response can be obtained by using linear combination of FD base vectors for the SD beams. The channel frequency response corresponds to the power delay profile.

### (Type 2 Port Selection Codebook/Enhancement/Further Enhancement)

In type 2 port selection (PS) CSI (type 2 PS codebook) of Rel. 15, the UE does not need to derive an SD beam in consideration of 2D-DFT, as with the type 2 CSI. A base station transmits CSI-RSs by using K CSI-RS ports beamformed in consideration of a set of SD beams. The UE selects/identifies the best L (≤K) CSI-RS ports for each polarization, and reports indices of these ports in W₁. The type 2 PS CSI of Rel. 15 supports ranks 1 and 2.

Operation for type 2 PS CSI (enhanced type 2 PS codebook) of Rel. 16 is the same as that for the type 2 CSI of Rel. 16, except for SD beam selection. The type 2 PS CSI of Rel. 15 supports ranks 1 to 4.

For layer l∈{1, 2, 3, 4}, per-subband (subband (SB)-wise) precoder generation is given by the following equation.

$${W}_{l} ( {N}_{t} \times {N}_{3} ) = {QW}_{1} {W}_{l}^{∼} {W}_{f , l}^{H} \qquad ( Y2 )$$

Here, Q (Nₜ×K) indicates K SD beams used for CSI-RS beamforming. W₁(K×2L) is a block diagonal matrix. W\tilde{ }ₗ(2L×M) is an LC coefficient matrix. W_{f,l}(N₃×M) is formed by N₃ FD-DFT base vectors (FD base vectors). K is configured by a higher layer. L is configured by a higher layer. P_{CSI-RS}∈{4, 8, 12, 16, 24, 32}. When P_{CSI-RS}>4, L∈{2, 3, 4}.

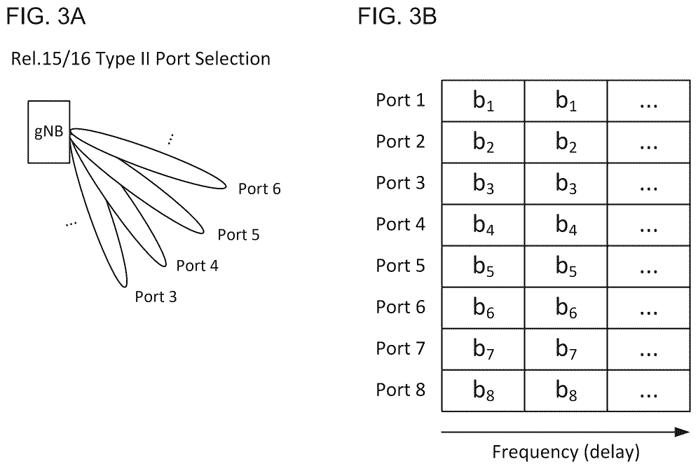

In type 2 PS CSI of Rel. 15/16, each CSI-RS port #i is associated with an SD beam (bᵢ) (FIGS. 3A and 3B).

The type 2 PS CSI of Rel. 16 reduces the number of FD bases from N₃ to Mᵥ (Mᵥ<<N₃) in a manner similar to that of type 2 CSI of Rel. 16, thereby reducing overhead as compared with that for the type 2 PS CSI of Rel. 15.

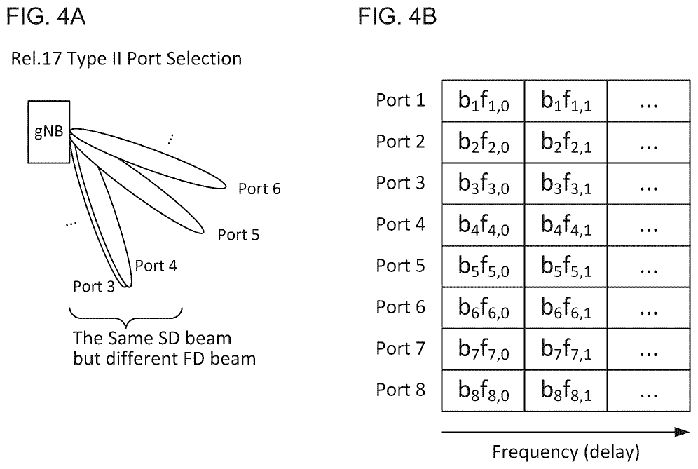

In type 2 port selection CSI/codebook of Rel. 17 (further enhanced type 2 port selection codebook), each CSI-RS port #i is associated with an SD-FD beam pair (pair of SD beam bᵢ and FD beam f_{i,j} (where j is a frequency index)) in place of an SD beam (FIGS. 4A and 4B). In this example, ports 3 and 4 are associated with the same SD beam and are associated with different FD beams.

Frequency selectivity of channel frequency response observed by the UE, based on an SD beam-FD beam pair can be reduced by delay pre-compensation more than frequency selectivity of channel frequency response observed by the UE, based on an SD beam.

A primary scenario for the type 2 port selection codebook of Rel. 17 is FDD. Channel reciprocity based on SRS measurement is imperfect (there is a possibility that an angle of a UL beam and an angle of a DL beam are different from each other, a UL frequency and a DL frequency are different from each other in FDD, effective antenna spacing differs between these UL and DL frequencies). However, the base station can obtain/select some pieces of partial information (dominant angle and delay (SD beam and FD beam)). By using SRS measurement by the base station in addition to CSI reporting, the base station can obtain CSI for determination of a DL MIMO precoder. In this case, some CSI reports may be omitted to reduce CSI overhead.

In the Rel-17 (further enhanced) type 2 port selection codebook, values of α, M, and β (parameter combination) are determined by a higher layer parameter “paramCombination-r17” (codebook parameter configuration). A precoding matrix indicated by a PMI is determined from (L+M) vectors. Here, L=K₁/2, and K₁=αP_{CSI-RS}.

In type 2 PS CSI of Rel. 17, each CSI-RS port is beamformed by using an SD beam and an FD base vector. Each port is associated with an SD-FD pair.

For given layer l, information based on the following equation may be reported by the UE.

$${W}_{l} ( K \times {N}_{3} ) = {W}_{1} {W}_{l}^{∼} {W}_{f , l}^{H} \qquad ( Y3 )$$

For W₁(K×2L), each matrix block is formed by L columns of a K×K identity matrix. The base station transmits K beamformed CSI-RS ports. Each port is associated with an SD-FD pair. The UE selects L ports from K ports, and reports, as part of PMI(W_{1,l}), the selected ports to the base station. Note that, in Rel. 16, each port is associated with an SD beam.

W\tilde{ }₁(2L×Mᵥ) is a matrix formed by combination coefficients (subband complex LC coefficients). UP to K₀ NZCs are reported. The report is formed by two parts: a bitmap for identifying an NZC location, and a quantized NZC. In a specific case, the bitmap can be omitted. Note that, in Rel. 16, the bitmap for the NZC location is always reported.

W_{f,l}(N₃×Mᵥ) is a matrix formed by N₃ FD base (FD DFT base) vectors. Mᵥ FD bases are present for each layer. The base station may delete W_{f,l}. When W_{f,l} is ON, Mᵥ additional FD bases are reported. When W_{f,l} is OFF, no additional FD bases are reported. Note that, in Rel. 16, W_{f,l} is always reported.

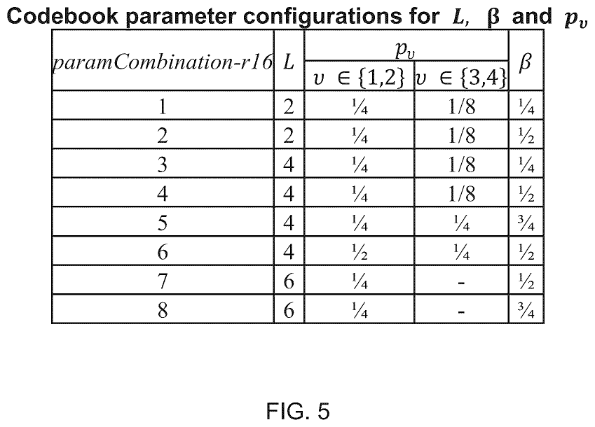

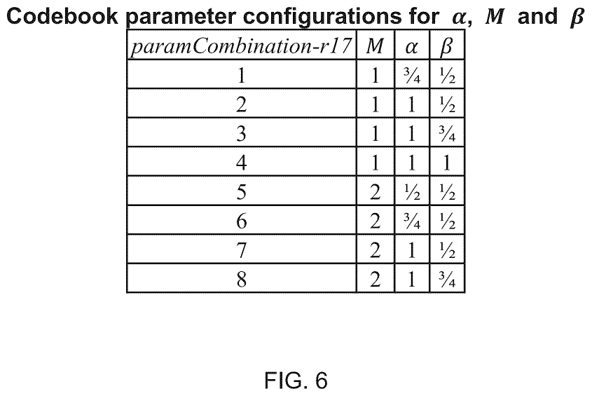

FIG. 5 shows an example of the parameter combination for the Rel-16 type 2 codebook. FIG. 6 shows an example of the parameter combination for the Rel-17 type 2 port selection codebook.

### (Configuration of CSI-RS Resource and CSI Report)

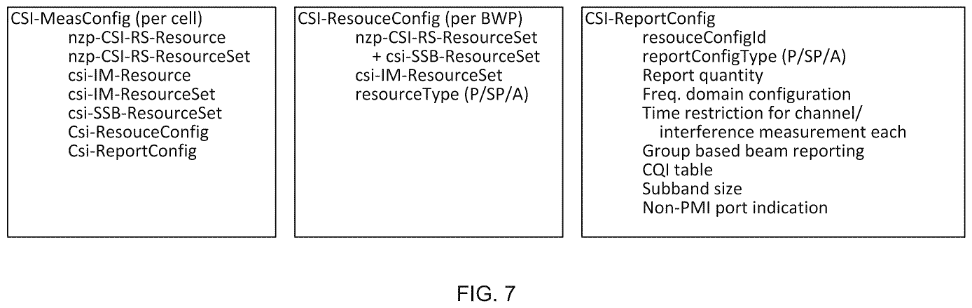

As shown in an example in FIG. 7, a relationship between a CSI-RS resource and a CSI report is configured by CSI measurement configuration (CSI-MeasConfig) configured for each cell, CSI resource configuration (CSI-ResourceConfig) configured for each BWP, and CSI report configuration (CSI-ReportConfig).

CSI-MeasConfig includes at least one of a non-zero power (NZP) CSI-RS resource configuration “nzp-CSI-RS-Resource,” an NZP-CSI-RS resource set configuration “nzp-CSI-RS-ResourceSet,” a CSI-interference measurement (IM) resource configuration “csi-IM-Resource,” a CSI-IM resource set configuration “csi-IM-ResourceSet,” a CSI-SSB resource set configuration “csi-SSB-ResourceSet,” a CSI resource configuration “CSI-ResouceConfig,” and a CSI report configuration “CSI-ReportConfig.”

CSI-ResourceConfig includes at least one of nzp-CSI-RS-ResourceSet, csi-SSB-ResourceSet, csi-IM-ResourceSet, and a resource type “resourceType (periodic (P)/semi-persistent (SP)/aperiodic (A)).”

CSI-ReportConfig includes at least one of a resource configuration ID “resourceConfigId,” a report configuration type “reportConfigType (P/SP/A),” a report quantity, a frequency domain configuration, a time restriction on each of channel measurement/interference measurement, a group-based beam report, a COI table, a subband size, and a non-PMI port indication.

### (Doppler Shift)

It is studied that time-domain correlation/Doppler-domain information is used to enhance/improve a capability for a CSI report for a UE moving at high speed/medium speed. For example, studies have been carried out on improvement of the type 2 codebook of Rel. 16/17 and reporting of time domain channel properties (TDCP) measured via a tracking CSI-RS (tracking RS (TRS)) from the UE without changing spatial domain bases and frequency domain bases.

A channel coherent time (CCT) depends on a maximum Doppler shift. The channel coherent time is a time when measured channel properties are available or a time until measured channel properties become unavailable (channel aging). The maximum Doppler shift is estimated by a relative speed between a transmitter and a receiver. The channel coherent time T. is approximated by 1/Δfₘₐₓ. Here, Δfₘₐₓ=v/λ. As the moving speed of the UE is higher, the channel coherent time is shorter. For example, the channel coherent time falls below 10 ms when the moving speed exceeds approximately 25 km/h at a carrier frequency of 4.5 GHZ. How to handle such high moving speed and short channel coherent time is an issue.

A TRS is supported to track a Doppler shift. However, the TRS has the following issues.
The number of ports per CSI-RS resource set is limited to only one. Each CSI-RS resource uses a single port.
A configurable periodicity is 10 ms or greater.
A CSI report for the TRS is not assumed. There is no report configuration for a P-TRS. The report can be configured, but a report quantity (reportQuantity) is set to only ‘none.’ Up to 16 CSI-RS resources are used per CSI-RS resource set.

The TRS is arranged in resources of the time domain and the frequency domain. Measurement of influence by a Doppler shift requires, in a specific frequency domain resource, a plurality of RSs in the time domain.

It is conceivable that a CMR is used for the measurement of the influence by the Doppler shift. However, an RS to be used for the measurement depends on UE implementation.

Information related to the Doppler shift is not supported for a quantity of the CSI report. Information for determination of W=W₁W₂ is reported by the UE via a CSI codebook (PMI). Here, W₁ is wideband property, and indicates a spatial beam. W₂ is subband property, and indicates a coefficient of amplitude/phase for each spatial beam.

For the measurement related to the Doppler shift, the following cases are conceivable: case 1 where the UE performs measurement, based on a CSI-RS; and case 2 where the base station performs measurement, based on an SRS. For judgment of the influence by the Doppler shift, the following cases are conceivable: case 1-1 where the UE performs judgment, based on a CSI-RS measurement result; case 1-2 where the base station performs judgment, based on a CSI-RS measurement result reported by the UE; and case 2-1 where the base station performs judgment, based on an SRS measurement result.

### (Relationship Between Timings of CSI-RS Measurement and CSI Report)

A CSI-RS measurement window and a CSI reporting window are under study. In the CSI-RS measurement window, one or more CSI-RS occasions may be measured. CSI to be reported may be associated with the CSI reporting window.

On the assumption of the CSI report in a slot n, the length of the Doppler domain/time domain base vector may be represented by N₄. In the CSI measurement window of slot [k, k+Wₘₑₐₛ−1], one or more CSI occasions for calculation of the CSI report may be measured. Here, k may be a slot index, and Wₘₑₐₛ may be a measurement window length (the number of slots). The CSI occasion may be configured in CSI-ReportConfig. The CSI reporting window of slot [l, l+W_{CSI}−1] may be associated with the CSI report in the slot n. Here, l may be a slot index, and W_{CSI} may be a reporting window length (the number of slots). The position of a CSI reference resource may be represented by n_{ref}.

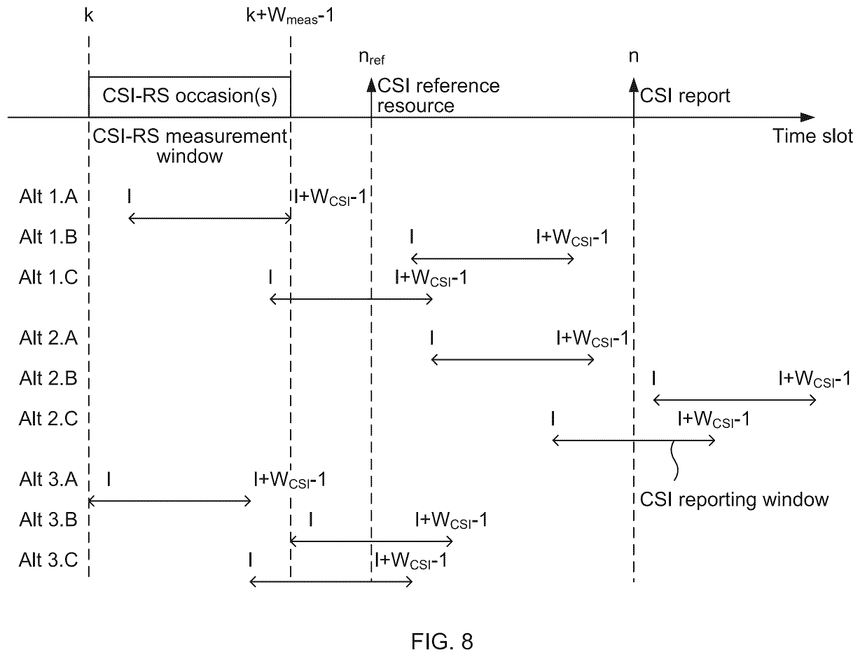

To improve the type 2 codebook, the CSI report and measurement (CSI-RS measurement window/CSI reporting window) may follow at least one of some alternatives below, as shown in FIG. 8.
[Alternative 1] As in one of the following, for the boundary of the CSI reporting window, the CSI reference resource slot n_{ref} may be considered.

$$l + {W}_{CSI} - 1 \leq {n}_{ref} \qquad [ [ Alternative 1. A ] ]$$

$${n}_{r e f} \leq l \qquad [ [ Alternative 1. B ] ]$$

$$l < {n}_{ref} and {n}_{ref} \leq l + {W}_{CSI} - 1 \qquad [ [ Alternative 1. C ] ]$$

[Alternative 2] As in one of the following, for the boundary of the CSI reporting window, a reporting slot n may be considered.

$$l + {W}_{CSI} - 1 \leq n \qquad [ [ Alternative 2. A ] ]$$

$$n \leq l \qquad [ [ Alternative 2. B ] ]$$

$$l < n and n \leq l + {W}_{CSI} - 1 \qquad [ [ Alternative 2. C ] ]$$

[Alternative 3] As in one of the following, for the boundary of the CSI reporting window, the last slot k+Wₘₑₐₛ−1 of the measurement window may be considered.
   [[Alternative 3.A]] In a special case in which l=k and W_{CSI}=Wₘₑₐₛ, l+W_{CSI}−1≤k+Wₘₑₐₛ−1

$$k + {W}_{m e a s} - 1 \leq l \qquad [ [ Alternative 3. B ] ]$$

[[Alternative 3.C]] In a special case in which l=k, n=l+W_{CSI} or l=k, and n<l+W_{CSI}, l<k+Wₘₑₐₛ−1 and k+Wₘₑₐₛ−1≤l+W_{CSI}−1

Note that, in existing specifications, n_{ref}=n−n_{ref}, l=n_{ref}, W_{CSI}=1, k≤n_{ref}, and Wₘₑₐₛ=1.

When the CSI reporting window overlaps the CSI-RS occasion, it can also be interpreted that CSI to be reported is obtained by actual measurement. When the CSI reporting window does not overlap the CSI-RS occasion, it can also be interpreted that CSI to be reported is obtained by prediction in the UE. It can also be interpreted that the CSI report includes CSI obtained by actual measurement (measured CSI) and CSI obtained by prediction in the UE (predicted CSI) (alternatives 1.C and 3.C).

For CSI report and measurement for improvement of the type 2 codebook for high speed/medium speed, it is studied that one of alternatives 1.B and 2.B is used when UE-side prediction is assumed. In alternative 1.B, the UE can report CSI during a duration time after the CSI reference resource. In alternative 2.B, the UE can report CSI during a duration time after the CSI reporting slot. An existing report includes CSI in a slot for a CSI reference resource. A CSI-RS occasion to be measured depends on implementation.

### (Codebook Structure)

A codebook structure may be one of alternatives 2 and 3 below (excluding alternative 1).

### [Alternative 2] Doppler Domain (DD) Base

$$W = {W}_{1} {( {W}_{f} ⊗ {W}_{d} )}^{H} \qquad ( Z1 )$$

Here, W is a matrix having N_{Tx}N₃ rows and N₄ columns. W_{f} is a matrix having N₃ rows and M columns (similar to Rel. 16). W₁ is a matrix having N_{Tx} rows and 2L columns (similar to Rel. 16). W₂^{\hat{ }} is a matrix having 2L rows and MD columns. W_{d} is a matrix having N₄ rows and D columns.

N₄ is the number of time domain (TD) units (TD bases). D is the number of compressed/selected TD units (TD bases).

The DD base may be selected commonly for all the SD and FD bases, or may be selected independently for a plurality of different SD and FD bases.

There is a tradeoff between TD granularity and overhead. A greater D leads to reporting with finer accuracy, and greater overhead. A smaller D leads to reporting with coarser accuracy, and smaller overhead.

[Alternative 3] Reuse of Existing (Rel-16/17) Type 2 Codebook with Plurality of W₂\tilde{ } and Single W₁ and W_{f}

$$W = {W}_{1} {( {W}_{f} ⊗ I )}^{H} \qquad ( Z2 )$$

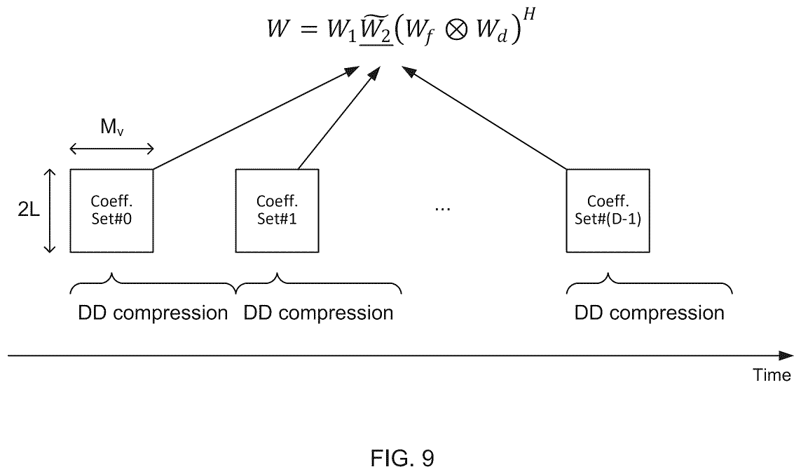

FIG. 9 shows an example of alternative 2 for the codebook structure. Each of D coefficient sets #0, #1, . . . , #(D−1) is a matrix having 2L rows and Mᵥ columns, and W₂\tilde{ } is a matrix having 2L rows and MᵥD columns. DD compression is performed on each coefficient set.

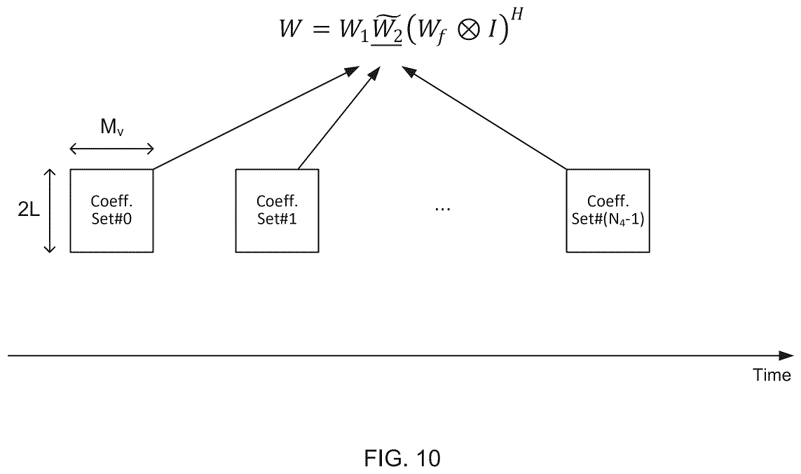

FIG. 10 shows an example of alternative 3 for the codebook structure. Each of N₄ coefficient sets #0, #1, . . . , #(N₄−1) is a matrix having 2L rows and Mᵥ columns, and W₂\tilde{ } is a matrix having 2L rows and MᵥN₄ columns.

Alternatives 2 and 3 may depend on N₄.

For CSI report and measurement for improvement of the type 2 codebook for high speed/medium speed, it is studied that K (>1) NZP CSI-RS resources received via a single trigger instance are supported for CMRs and for aperiodic (A/AP) CSI-RS based channel measurement in the same CSI-RS resource set. Spacing between two consecutive AP-CSI-RS resources in K NZP CSI-RS resources may be m slots.

It is studied that a TRS-based TDCP report includes standalone auxiliary feedback information for enabling at least one of CSI report configuration, a codebook configuration parameter, and base station-side (gNB-side) CSI prediction to be improved. It is studied that the TDCP report is not conditional on another UCI parameter and is not reported together with a CQI/PMI/RI/(CQI) associated with a codebook. This may not prevent the TDCP report from being multiplexed with another UCI parameter on a PUCCH/PUSCH. Aperiodic reporting of the TDCP report may be supported.

### (Priority Rule for CSI Report)

In the priority rule for CSI reports, the CSI reports are associated with a priority value Pri_{iCSI}(y, k, c, s)=2·N_{cells}·Mₛ·y+N_{cells}·Mₛ·k+Mₛ·c+S. y=0 for an A-CSI report communicated on a PUSCH. y=1 for an SP-CSI report communicated on a PUSCH. y=2 for an SP-CSI report communicated on a PUCCH. y=3 for a P-CSI report communicated on a PUCCH. k=0 for a CSI report that communicates L1-RSRP or L1-SINR. k=1 for a CSI report that does not communicate L1-RSRP or L1-SINR. c is a serving cell index. N_{cells} is a maximum number of configured serving cells (value of a higher layer parameter “maxNrofServingCells”). s is a CSI report configuration ID (reportConfigID). Mₛ is a maximum number of configured CSI report configurations (value of a higher layer parameter “maxNrofCSI-ReportConfigurations”). A case where a priority value associated with a first CSI report is lower than a priority value associated with a first CSI report means that the first CSI report is prioritized over the second CSI report (a priority of the first CSI report is higher than a priority of the second CSI report).

### (CSI Processing Criteria)

The UE reports the number N_{CPU} of supported simultaneous CSI calculations (maximum number of simultaneous CSI calculations) by using the following capability information. N_{CPU} implies the number of CSI processing units (CPUs).
simultaneousCSI-ReportsPerCC in csi-ReportFramework in MIMO-ParametersPerBand MIMO-ParametersPerBand is used to communicate a MIMO-related parameter specific to a certain band. csi-ReportFramework indicates whether the UE supports a CSI report framework. simultaneousCSI-ReportsPerCC indicates the number of CSI reports for which the UE can simultaneously measure and process reference signals in one CC of a band for which this capability is provided. The CSI report includes periodic, semi-persistent, and aperiodic CSI, and any latency class and codebook type. The CSI report in simultaneousCSI-ReportsPerCC includes a beam report and a CSI report.
simultaneousCSI-ReportsAllCC in CA-ParametersNR simultaneousCSI-ReportsAllCC indicates whether the UE supports a CSI report framework, and the number of CSI reports possible to be simultaneously processed by the UE over all the CCs (master cell group (MCG) and secondary cell group (SCG) in a case of NR-DC). The CSI report includes periodic, semi-persistent, and aperiodic CSI, and any latency class and codebook type. The CSI report in simultaneousCSI-ReportsAllCC includes a beam report and a CSI report. This parameter is further limited by simultaneousCSI-ReportsPerCC and Phy-ParametersFRX-Diff in MIMO-ParametersPerBand for each band in a given band combination.

When the UE supports N_{CPU} simultaneous CSI calculations, the UE is assumed to include N_{CPU} CPUs for processing of the CSI report. When L CPUs are occupied for calculation of CSI reports in one given OFDM symbol, the UE includes N_{CPU}-L unoccupied CPUs. In a case where, in the same OFDM symbol with N_{CPU}-L unoccupied CPUs, N CSI reports are initiated to occupy respective CPUs that correspond to O_{CPU}⁽ⁿ⁾ for each CSI report n=0, . . . , N−1 of the N CSI reports (number of consumed CPUs for CSI report n), the UE is not required to update (calculate, process) N−M requested CSI reports based on the lowest priority (highest priority value Pri_{iCSI}(y, k, c, s)) following a priority rule. Here, 0≤M≤N is a maximum value with which Σₙ₌₀^{M-1}O_{CPU}⁽ⁿ⁾≤N_{CPU}−L is satisfied.

The UE does not assume being configured with an A-CSI trigger state including more than N_{CPU} report settings. Processing of the CSI reports occupies some CPUs in some symbols, as in processing 1 to processing 3 below. The processing of the CSI reports consumes zero, one, or more CPUS (O_{CPU}, number of consumed CPUs).

### Processing 1

In a case where CSI reporting with CSI-ReportConfig with a higher layer parameter “reportQuantity” set to ‘none’ and with CSI-RS-ResourceSet with a higher layer parameter “trs-Info” is configured, O_{CPU}=0.

### Processing 2 (Beam Management)

In CSI reporting with CSI-ReportConfig with a higher layer parameter “reportQuantity” set to ‘cri-RSRP,’ ‘ssb-Index-RSRP,’ ‘cri-SINR,’ ‘ssb-Index-SINR,’ ‘cri-RSRP-Capability [Set] Index,’ ‘ssb-Index-RSRP-Capability [Set] Index,’ ‘cri-SINR-Capability [Set] Index,’ ‘ssb-Index-SINR-Capability [Set] Index,’ or ‘none’ (in a case where CSI-RS-ResourceSet with a higher layer parameter “trs-Info” is not configured), O_{CPU}=1.

### Processing 3

In CSI reporting with CSI-ReportConfig with a higher layer parameter “reportQuantity” set to ‘cri-RI-PMI-CQI,’ ‘cri-RI-i1,’ ‘cri-RI-i1-CQI,’ ‘cri-RI-i1-CQI,’ ‘cri-RI-CQI,’ or ‘cri-RI-LI-PMI-CQI,’ O_{CPU} follows processing 3-1 to processing 3-3 below.

Processing 3-1 (Case where the UE can Use a Maximum of a UE Capability)

When a CSI report without transmission of a PUSCH with at least one of a transport block and a HARQ-ACK is triggered aperiodically in a case where max(μ_{PDCCH}, μ_{CSI-RS}, μ_{UL})≤3 and where L=0 CPUs are occupied, the CSI corresponds to single CSI with wideband frequency-granularity and four or less CSI-RS ports in a single resource without CRI reporting, codebookType is set to ‘typeI-SinglePanel,’ and reportQuantity is set to ‘cri-RI-CQI,’ O_{CPU}=N_{CPU}. μ_{PDCCH} is a subcarrier spacing (SCS) configuration for a PDCCH. μ_{CSI-RS} is an SCS configuration for a CSI-RS. μ_{UL} is an SCS configuration for a UL BWP in which a CSI report is transmitted.

### Processing 3-2 (Case of NCJT CSI)

When CSI-ReportConfig with codebookType set to ‘typeI-SinglePanel’ is configured, and a CSI-RS resource set for channel measurement corresponding to this is configured with two resource groups and N resource pairs, O_{CPU}=X·N+M. Here, X is the number of CPUs occupied by a CMR pair following the UE capability. A UE capability “mTRP-CSI-numCPU-r17” indicates the number of CPUs occupied by a CMR pair for NCJT CSI hypotheses. M=M₁+M₂ for M₁ resources and M₂ resources associated with CRI values for resource group 1 with K₁ resources and resource group 2 with K₂ resources in an NZP CSI-RS resource set for channel measurement with Kₛ=K₁+K₂ resources.

### Processing 3-3

In a case other than that case, O_{CPU}=Kₛ. Kₛ is the number of CSI-RS resources in a CSI-RS resource set for channel measurement.

A CSI report with CSI-ReportConfig with a higher layer parameter “reportQuantity” not configured to ‘none’ occupies one or more CPUs in a plurality of OFDM symbols (CPU occupancy duration, CPU occupation duration) below.
A P-CSI report or an SP-CSI report occupies one or more CPUs, from the first symbol of one earliest resource from among resources with the last respective CSI-RS/CSI-IM/SSB occasions previous to corresponding CSI reference resources, from among resources of a plurality of CSI-RS/CSI-IM/SSB resources for channel or interference measurement, to the last symbol for a PUSCH/PUCCH that communicates the report and is configured with the report (CPU occupancy duration 1). The P-CSI report or SP-CSI report excludes the first SP-CSI report on a PUSCH after a PDCCH that triggers the report. The time when the P-CSI report or SP-CSI report occupies one or more CPUs may be referred to as CPU occupancy duration 1.
An A-CSI report occupies one or more CPUs, from the first symbol after a PDCCH that triggers the CSI report to the last symbol for a PUSCH/PUCCH that communicates the report and is configured with the report (CPU occupancy duration 2). When reception of the PDCCH includes two corresponding PDCCH candidates from two search space sets, a PDCCH candidate that ends later, from among the two PDCCH candidates, is used to determine the CPU occupancy duration. The time when the A-CSI report occupies one or more CPUs may be referred to as CPU occupancy duration 2.
The first SP-CSI report on the PUSCH after the PDCCH trigger occupies one or more CPUs, from the first symbol after the PDCCH to the last symbol for a PUSCH that communicates the report and is scheduled with the report (CPU occupancy duration 3). When reception of the PDCCH includes two corresponding PDCCH candidates from two search space sets, a PDCCH candidate that ends later, from among the two PDCCH candidates, is used to determine the CPU occupancy duration. The time when the SP-CSI report occupies one or more CPUs may be referred to as CPU occupancy duration 3.

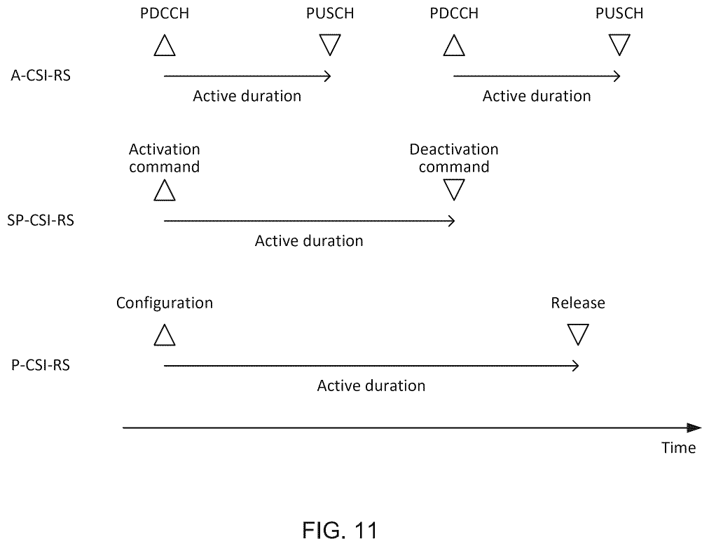

In any slot, the UE does not assume that an active BWP includes more active CSI-RS ports or active CSI-RS resources than those reported as a capability. NZP CSI-RS resources are active in duration (duration of time, active duration) defined as follows (FIG. 11).
Duration for an A-CSI-RS starts at an end of a PDCCH including a request therefor, and ends at an end of a scheduled PUSCH including a report associated with the A-CSI-RS.
Duration for an SP-CSI-RS starts at an end of a time when an activation command is applied, and ends at an end of a time when a deactivation command is applied.
Duration for a P-CSI-RS starts when the P-CSI-RS is configured by higher layer signaling, and ends when the P-CSI-RS configuration is released.

If a CSI-RS resource is referred to by N CSI report settings, the CSI-RS resource and a CSI-RS port in the CSI-RS resource are counted as N times.

A P-CSI-RS is always counted as an active CSI-RS, irrespective of whether the P-CSI-RS is received in an OFDM symbol therefor.

The UE reports, for each band, UE capability information (codebookParameter) related to a CSI report codebook.

codebookParameter indicates a codebook (type), and a corresponding parameter supported by the UE. Reporting of a parameter corresponding to a type 1 single panel is mandatory. Reporting of parameters corresponding to type 1 multi-panel, type 2, and type 2 port selection is optional. The parameter may include at least one of maxNumberTxPortsPerResource, maxNumberResourcesPerBand, and totalNumberTxPortsPerBand. maxNumberTxPortsPerResource indicates a maximum number of transmission ports in one resource. maxNumberResourcesPerBand indicates a maximum number of resources used simultaneously over all the CCs in one band. totalNumberTxPortsPerBand indicates a maximum number of transmission ports used simultaneously over all the CCs in one band.

The TDCP report supports an A-CSI report with valid information, but the number of consumed CPUs for this case is not defined. For Doppler CSI, an A-CSI report with information greater than Rel-16 enhanced type 2 CSI is assumed. In this case, the number of consumed CPUs is indefinite.

It is indefinite that, when at least one of Doppler Rel-18 type 2 CSI and a TRS-based TDCP report is supported, how a codebook parameter for at least one of the Doppler Rel-18 type 2 CSI and the TRS-based TDCP report is reported and what is defined for active duration. Accordingly, unless a capability/processing time for a CSI report is definite, throughput reduction/communication quality degradation and the like may be caused.

Thus, the inventors of the present invention came up with the idea of a capability/processing time for a CSI report.

Embodiments according to the present disclosure will be described in detail with reference to the drawings as follows. Note that respective embodiments (for example, respective cases) below may each be employed individually, or at least two of the respective embodiments may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, “to have a capability of . . . ” may be interchangeably interpreted as “to support/report a capability of . . . ”.

In the present disclosure, a_{b}^{c} and a_b\hat{ }c may be interchangeably interpreted. In the present disclosure, a_{b} and a_b may be interchangeably interpreted. In the present disclosure, ac and a\hat{ }c may be interchangeably interpreted.

In the present disclosure, a base, a DFT base, a base vector, and a DFT base vector may be interchangeably interpreted. In the present disclosure, an SD base, an SD-DFT base, a beam, an SD beam, an SD vector, and an SD 2D-DFT vector may be interchangeably interpreted. In the present disclosure, L, the number of SD beams, the number of beams, and the number of SD 2D-DFT vectors may be interchangeably interpreted. In the present disclosure, an FD base, an FD-DFT base, fᵢ, an FD beam, an FD vector, an FD base vector, and an FD-DFT base vector may be interchangeably interpreted. In the present disclosure, a combination coefficient, an LC coefficient, a subband complex LC coefficient, and a combination coefficient matrix may be interchangeably interpreted. In the present disclosure, co-phasing, phase compensation, phasing, phase difference, a phase relationship, phase combination, and a phase may be interchangeably interpreted. In the present disclosure, layer l and layer k may be interchangeably interpreted. In the present disclosure, difference and relative may be interchangeably interpreted. In the present disclosure, amplitude and an amplitude coefficient may be interchangeably interpreted. In the present disclosure, a phase and a phase coefficient may be interchangeably interpreted. In the present disclosure, the strongest coefficient, the strongest amplitude coefficient, and the strongest amplitude may be interchangeably interpreted. In the present disclosure, a quantization table and a quantization method may be interchangeably interpreted.

In the present disclosure, a time domain (TD) base and a Doppler domain (DD) base may be interchangeably interpreted. In the present disclosure, a time domain (TD) unit, a Doppler domain (DD) unit, a time domain (TD) base, a Doppler domain (DD) base, a TD-DFT base, and a DD-DFT base may be interchangeably interpreted.

In the present disclosure, a CSI-RS, a TRS, an NZP-CSI-RS resource set with TRS information (trs-Info), and NZP-CSI-RS resources having the same port for all of the NZP-CSI-RS resources may be interchangeably interpreted.

In the present disclosure, Doppler type 2 CSI and Rel-18 type 2 CSI may be interchangeably interpreted.

In the present disclosure, a window, a CSI-RS measurement window, one or more CSI-RS occasions, one or more time occasions, and a CSI reporting window may be interchangeably interpreted.

In the present disclosure, a CSI report may include measured CSI/predicted CSI in one or more time occasions in a CSI reporting window. The measured CSI may be a measurement result in one or more time occasions in a CSI-RS measurement window. The predicted CSI may be a prediction result in one or more time occasions in a CSI reporting window.

### (Radio Communication Method)

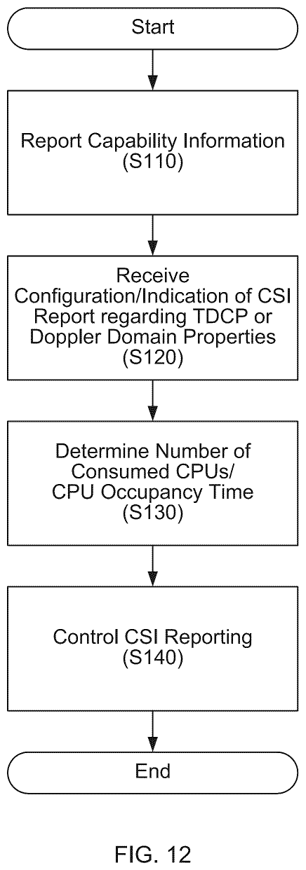

As shown in FIG. 12, a UE may report capability information (UE capability) related to a maximum number N_{CPU} of CSI reports processed simultaneously by a terminal (S110). The capability information may include at least one of simultaneousCSI-ReportsPerCC and simultaneousCSI-ReportsAllCC. Subsequently, the UE may receive a configuration/indication of a CSI report regarding TDCP or Doppler domain properties (S120), may determine, based on the configuration/indication, the number of CSI processing units/CPU occupancy time for the CSI report (S130), and may control the CSI report, based on the number of CSI processing units/CPU occupancy time (S140). The UE may process CSI reports under a condition that a total number of consumed CPUs occupied in the same symbol is N_{CPU} or less. For example, when a total number of consumed CPUs occupied in the same symbol exceeds N_{CPU}, the UE may process CSI reports with a total number of consumed CPUs occupied in the same symbol being N_{CPU} or less, in descending order of priority (ascending order of priority value).

In each of the respective embodiments, the number of CPUS, the number of consumed CPUs, a quantity of processing, O_{CPU}, and O_{CPU}⁽ⁿ⁾ may be interchangeably interpreted.

### Embodiment #A1

This embodiment relates to the number of CPUs for a TDCP report.

The TDCP report may consume/occupy X (>0, non-zero) CPUs.

### Option 1

The TDCP report may satisfy at least one of some options below.
Option 1-1: a TRS is configured as a CSI-RS. In other words, a CSI-RS resource set is configured with TRS information (higher layer parameter “trs-Info”).
Option 1-2: a specific value of a report quantity (reportQuantity) is configured. For example, the specific value may be a value different from a value of an existing report quantity, may correspond to a TDCP report, or may be ‘tdcp,’ ‘timeDomainChannelProperty,’ or ‘timeDomainChannelProperties.’

### Option 2

An accurate/exact value of X may be at least one of some options below.
Option 2-1: single value defined in specification The value may be, for example, 1, 2, . . .
Option 2-1a: plurality of values defined in specification, or one of these plurality of values
Option 2-1b: value based on specific expression. For example, the specific expression may be N×1. Here, N may be associated with the number of NZP CSI-RS resources/NZP CSI-RS resource sets/NZP CSI-RS occasions/TRS resources/TRP resource sets/TRS occasions.
Option 2-2: value configured by RRC IE
Option 2-3: value indicated by MAC CE
Option 2-4: value indicated by DCI

The value of X may be a combination of some of the options above. For example, a plurality of values of X may be defined in the specification, and one of the plurality of values may be configured/indicated by the RRC IE/MAC CE/DCI. For example, a plurality of values of X may be configured by the RRC IE, and one of the plurality of values may be indicated by the MAC CE/DCI.

### Option 3

A condition to be considered for determination of the number of CPUs may include one condition of some options below, or may include an AND or OR condition of a plurality of conditions of some options below.
Option 3-1: condition of number N of NZP CSI-RS resources/NZP CSI-RS resource sets/NZP CSI-RS occasions/TRS resources/TRP resource sets/TRS occasions associated with CSI report
Option 3-2: condition of N-d Here, d may be a value defined in a specification, or a fixed value.

The UE may determine, based on the condition, the number of CPUs for the TDCP report.

This embodiment allows a UE to appropriately determine the number of CPUs for a TDCP report and to determine appropriate processing.

### Embodiment #A2

This embodiment relates to the number of CPUs for a Doppler type 2 CSI report.

The Doppler type 2 CSI report may consume/occupy X (>0, non-zero) CPUs greater than those for Rel-16 enhanced type 2 CSI.

### Option 1

An accurate/exact value of X may be at least one of some options below.
Option 1-1: single value defined in specification. The value may be, for example, 1, 2, . . .
Option 1-1a: plurality of values defined in specification, or one of these plurality of values.
Option 1-1b: value based on specific expression. For example, the specific expression may be Kₛ+Y. Here, Kₛ may be the number of CSI-RS resources in a CSI-RS resource set for channel measurement, and Y may be the number of additional CPUs for new processing. For example, the new processing may be UE-side CSI prediction.
Option 1-2: value configured by RRC IE.
Option 1-3: value indicated by MAC CE.
Option 1-4: value indicated by DCI.

The value of X may be a combination of some of the options above. For example, a plurality of values of X may be defined in the specification, and one of the plurality of values may be configured/indicated by the RRC IE/MAC CE/DCI. For example, a plurality of values of X may be configured by the RRC IE, and one of the plurality of values may be indicated by the MAC CE/DCI.

### Variations

UE capability O related to the number of CPUs occupied by one CSI-RS/TRS (in an instance of a single trigger) for a Doppler type 2 CSI report may be introduced. For example, O may be defined in a specification, or may be configured/indicated by an RRC IE/MAC CE/DCI. A value of O may be 1 or 2, or 3 or greater. When X=O*K, K may be the number of CSI-RSs/TRSs in one resource set.

UE capability O related to the number of CPUs occupied by K CSI-RSs/TRSs (in an instance of a single trigger) for a Doppler type 2 CSI report may be introduced. For example, O may be K+1, K+2, or K+L. K+L may mean that the UE is required to separately process K CSI-RS/TRS resources and to thereafter jointly process these resources for another attempt using additional L CPUs. Such another attempt may be CSI prediction. In this case, X may be equal to 0.

This embodiment allows a UE to appropriately determine the number of CPUs for a Doppler type 2 CSI report and to determine appropriate processing.

### Embodiment #1

This embodiment relates to CPU occupancy duration (time duration) for a CSI report for TDCP or Doppler properties.

The CSI report may occupy only part of a plurality of CPUs in existing duration. The existing duration may be at least one of CPU occupancy duration 1 to CPU occupancy duration 3 described above.

In the existing duration, a first CPU and a second remaining CPU of the plurality of CPUs may be occupied for first processing for the CSI report and first processing for the CSI report, respectively. A first CPU of the plurality of CPUs may be occupied for first processing for the CSI report in a first part of the existing duration, and a second remaining CPU of the plurality of CPUs may be occupied for second processing for the CSI report only in a second remaining part (part subsequent to the first part) of the existing duration. For example, the first processing and the second processing may be CSI measurement and CSI prediction, respectively.

The part of the plurality of CPUs (first CPU) may be K CPUs in a variation of Embodiment #2, or may be a CPU for the first processing (for example, CSI report). The remaining CPU (second CPU) may be L CPUs in a variation of Embodiment #2, or may be a CPU for the second processing (for example, CSI prediction).

This embodiment allows a UE to appropriately determine CPU occupancy duration for a CSI report for TDCP or Doppler properties and to determine appropriate processing.

### Embodiment #2

This embodiment relates to a UE capability.

### Embodiment #2-1

UE capability signaling (for example, a codebook parameter for Rel. 18) reported for at least one of Doppler Rel-18 type 2 CSI and a TDCP report may be introduced. The UE capability signaling may include at least one of some UE capabilities below.
Maximum number of transmission ports per CSI-RS resource (maxNumberTxPortsPerResource)
Maximum number of simultaneously used CSI-RS resources per band (maxNumberResourcesPerBand)
Total number of transmission ports simultaneously used over all CCs in band (totalNumberTxPortsPerBand)
Parameter “Lx” (for example, parameterLx) in codebook generation. Here, x is an index of a transmission port indicated by maxNumberTxPortsPerResource.
Amplitude scaling type (for example, amplitudeScalingType) supported by the UE. An amplitude scaling type for a wide band, or an amplitude scaling type for both a wide band and a subband.
Whether the UE supports amplitude subset restriction (for example, amplitudeSubsetRestriction)
Additional parameter combination. The additional parameter combination may be a combination including at least one parameter of the number L of beams, a factor pᵥ for determination of the number of FD-DET bases, and a factor β for determination of the number of NZCs.
Maximum number of supported ranks

### Option 1

Granularity of the reporting may follow at least one of the following.

### Option 1-1

The reporting may be performed for each CSI codebook type (codebookType). For example, the UE may separately report at least two of a Doppler type 2 CSI report, a TDCP report, or a CJT CSI report.

### Option 1-2

The reporting may be performed for each R configuration (value). R is a factor for determination of a ratio between a PMI subband size and a CQI subband size (CQI subband size/PMI subband size). For example, the UE may separately report a report for R=1 and a report for R=2.

### Option 1-2a

The reporting may provide one report for all the R configurations (values).

### Embodiment #2-2

The codebook parameter for at least one of the Doppler Rel-18 type 2 CSI and the TDCP report may be reuse of a codebook parameter reported for at least one of Rel-16 type 2, Rel-16 type 2 port selection, and Rel-17 type 2 port selection. Explicit capability reporting for at least one of the Doppler Rel-18 type 2 CSI and the TDCP report is unnecessary, and thus overhead for capability reporting can be suppressed.

### Embodiment #2-3

The codebook parameter for at least one of the Doppler Rel-18 type 2 CSI and the TDCP report may be calculated based on at least one piece of information below.
Codebook parameter for at least one of Rel-16 type 2, Rel-16 type 2 port selection, and Rel-17 type 2 port selection.
Weight factor. For example, X. Here, the weight factor, a coefficient, and a ratio may be interchangeably interpreted.

A codebook parameter for Doppler Rel-18 type 2 (for example, at least one of maxNumberTxPortsPerResource, maxNumberResourcesPerBand, and totalNumberTxPortsPerBand) may be calculated based on a codebook parameter for Rel-16 type 2 and a weight factor X. For example, the codebook parameter for Doppler Rel-18 type 2 may be equal to the codebook parameter for Rel-16 type 2+X. X may be defined in a specification, may be configured by an RRC IE, or may be indicated by a MAC CE/DCI. X may be one value of [0, 1], or may be greater than 1. The codebook parameter for Doppler Rel-18 type 2 may always be less than the codebook parameter for Rel-16 type 2, or may always be greater than the codebook parameter for Rel-16 type 2.

This embodiment allows a UE to appropriately report a codebook parameter for a CSI report for TDCP or Doppler properties and to determine appropriate processing.

### Embodiment #3

This embodiment relates to active CSI duration.

Active CSI duration for at least one of a TDCP report and Doppler Rel-18 type 2 CSI may be defined based on at least one rule of some rules below.

### Rule 1

The rule may be the same as a rule of Rel. 17. In other words, the rule may follow some of the following. This rule can eliminate, for the active CSI duration, influence on a specification.
Duration for an A-CSI-RS starts at an end of a PDCCH including a request therefor, and ends at an end of a scheduled PUSCH including a report associated with the A-CSI-RS.
Duration for an SP-CSI-RS starts at an end of a time when an activation command is applied, and ends at an end of a time when a deactivation command is applied.
Duration for a P-CSI-RS starts when the P-CSI-RS is configured by higher layer signaling, and ends when the P-CSI-RS configuration is released.

### Rule 2a

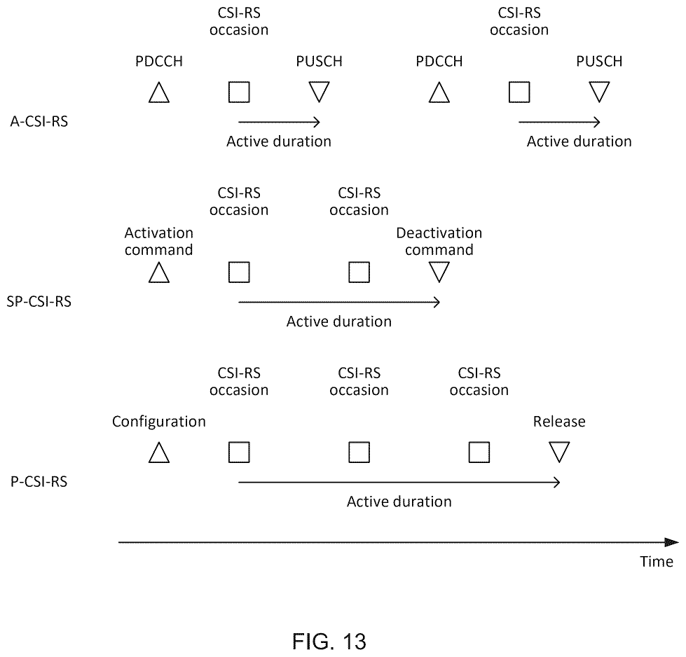

Duration for an A-CSI-RS starts at a first triggered CSI-RS occasion, and ends at an end of a scheduled PUSCH including a report associated with the A-CSI-RS (FIG. 13).

### Rule 2b

Duration for an SP-CSI-RS starts at the first CSI-RS occasion after application of an activation command, and ends at an end of a time when a deactivation command is applied (FIG. 13).

### Rule 2c

Duration for a P-CSI-RS starts at the first CSI-RS occasion after the P-CSI-RS is configured by higher layer signaling, and ends when the P-CSI-RS configuration is released (FIG. 13).

Rules 2a to 2c can shorten (minimize) active CSI duration, thereby allowing more CSI-RS ports/resources to be active for a certain long period.

The active CSI duration may be associated with at least one of a CSI measurement window and a CSI reporting window.

To associate the active CSI duration with at least one of the CSI measurement window and the CSI reporting window, at least one of some configurations below may be referred to.
Start of at least one of CSI measurement window and CSI reporting window
Length (duration) of at least one of CSI measurement window and CSI reporting window
Length of unit for determination of length of at least one of CSI measurement window and CSI reporting window. The unit may be a Doppler domain unit (DD unit).

This embodiment allows a UE to appropriately determine active duration for CSI-RS resources/CSI-RS ports for a CSI report for TDCP or Doppler properties and to determine appropriate processing.

### SUPPLEMENTS

### {Notification of Information to UE}

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

{Notification of Information from UE}

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
supporting of a report of a plurality of pieces of CSI in a time domain/Doppler domain; and
information related to the number of CSI reports possible to be simultaneously processed (in the same OFDM symbol).
information related to the number of CPUs occupied by one CSI-RS/TRS (in an instance of a single trigger) for a Doppler type 2 CSI report;
information related to the number of CPUs occupied by K CSI-RSs/TRSs (in an instance of a single trigger) for a Doppler type 2 CSI report; and
a codebook parameter for at least one of Doppler Rel-18 type 2 CSI and a TDCP report (for example, a codebook parameter for Rel. 18).

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating enabling of the functions of each embodiment, any RRC parameter for specific release (for example, Rel. 18/19), or the like.

When not supporting at least one of the specific UE capabilities or not configured with the specific information, the UE may apply operation of Rel. 15/16, for example.

### SUPPLEMENTARY NOTE

Regarding one embodiment of the present disclosure, the following supplementary notes of the invention will be given.

### {Supplementary Note 1}

A terminal including:
a receiving section that receives a configuration of a channel state information (CSI) report including a property of a time domain or a Doppler domain; and
a control section that determines, based on the configuration, a number of CSI processing units used for processing of the CSI report and a CSI processing unit occupancy time for the processing and that controls the CSI report, based on the number of CSI processing units and the CSI processing unit occupancy time.

### {Supplementary Note 2}

The terminal according to supplementary note 1, wherein the control section controls reporting of a capability related to at least one of a CSI reference signal (CSI-RS) resource and a port for the CSI report.

### {Supplementary Note 3}

The terminal according to supplementary note 1 or 2, wherein the control section determines at least one of an active CSI-RS resource and an active port for the CSI report, and assumes that a number of at least one of the active CSI-RS resources and the active ports does not exceed a value reported as a capability.

### {Supplementary Note 4}

The terminal according to any one of supplementary notes 1 to 3, wherein the control section determines duration for at least one of an active CSI-RS resource and an active port for the CSI report, and associates the duration with at least one of a CSI measurement window and a CSI reporting window.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

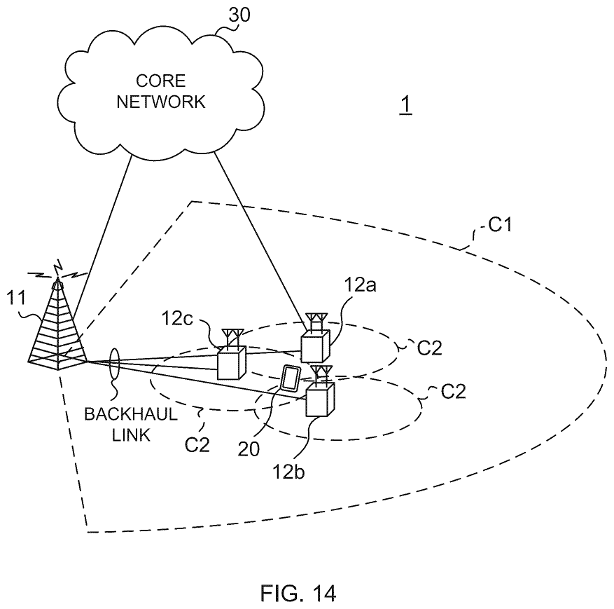

FIG. 14 is a diagram to show an example of a schematic structure of the radio communication system according to one embodiment. The radio communication system 1 (which may be simply referred to as system 1) may be a system implementing a communication using Long Term Evolution (LTE), 5th generation mobile communication system New Radio (5G NR), and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and the like.

The core network 30 may include network functions (NFs), such as a User Plane Function (UPF), an Access and Mobility management Function (AMF), a Session Management Function (SMF), Unified Data Management (UDM), an Application Function (AF), a Data Network (DN), a Location Management Function (LMF), and Operation, Administration and Maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information, and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

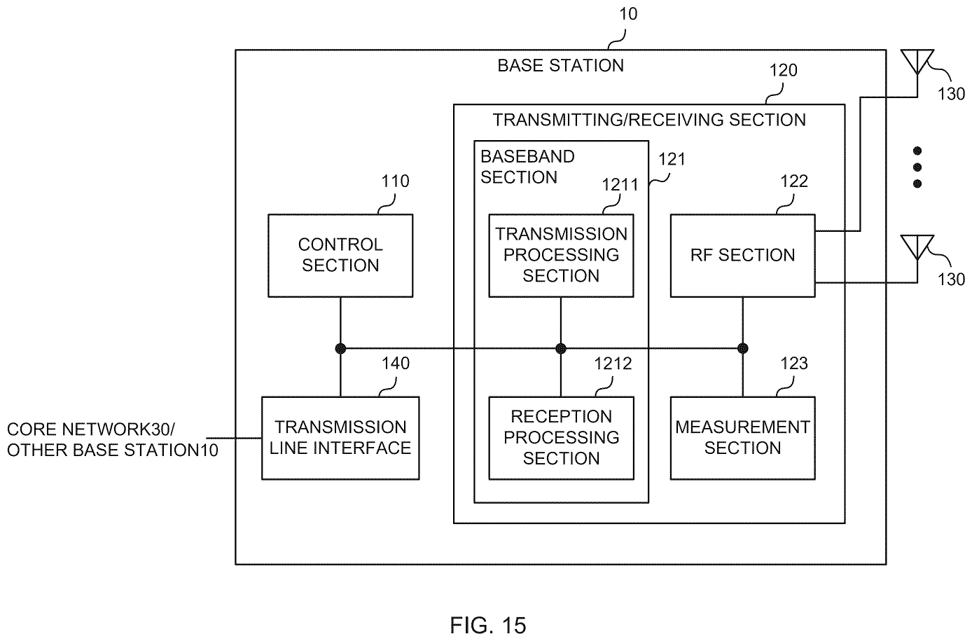

FIG. 15 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam or a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (for example, a network node that provides NFs) included in the core network 30, other base stations 10, and so on, and, for example, acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a configuration of a channel state information (CSI) report including a property of a time domain or a Doppler domain. The control section 110 may determine, based on the configuration, a number of CSI processing units used for processing of the CSI report and a CSI processing unit occupancy time for the processing, and may control the CSI report, based on the number of CSI processing units and the CSI processing unit occupancy time.

### (User Terminal)

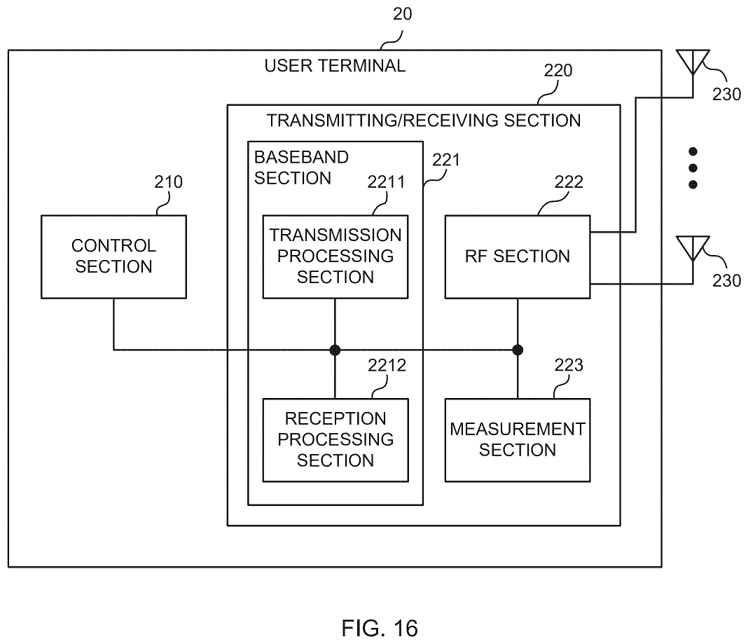

FIG. 16 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure received power (for example, RSRP), received quality (for example, RSRQ, SINR, SNR), signal strength (for example, RSSI), channel information (for example, CSI), or the like. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a configuration of a channel state information (CSI) report including a property of a time domain or a Doppler domain. The control section 210 may determine, based on the configuration, a number of CSI processing units used for processing of the CSI report and a CSI processing unit occupancy time for the processing, and may control the CSI report, based on the number of CSI processing units and the CSI processing unit occupancy time.

The control section 210 may control reporting of a capability related to at least one of a CSI reference signal (CSI-RS) resource and a port for the CSI report.

The control section 210 may determine at least one of an active CSI-RS resource and an active port for the CSI report, and may assume that a number of at least one of the active CSI-RS resources and the active ports does not exceed a value reported as a capability.

The control section 210 may determine duration for at least one of an active CSI-RS resource and an active port for the CSI report, and may associate the duration with at least one of a CSI measurement window and a CSI reporting window.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

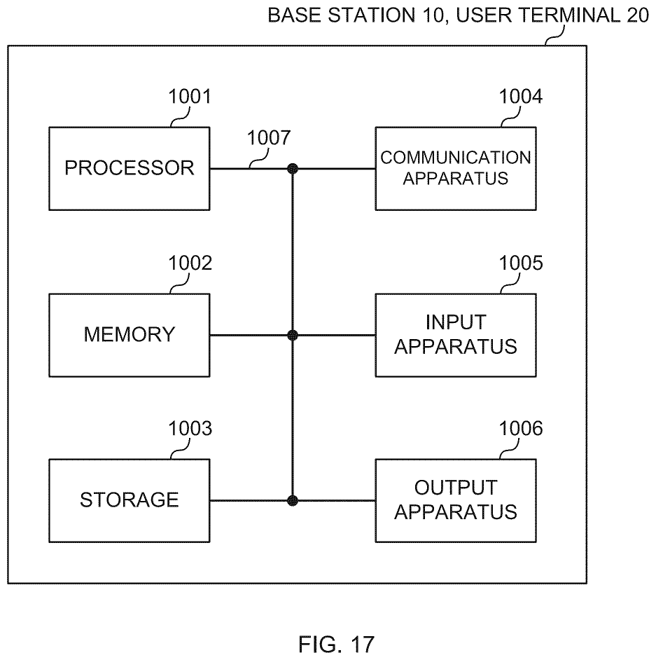

For example, a base station, a user terminal, and so on according to one embodiment of the present disclosure may function as a computer that executes the processes of the radio communication method of the present disclosure. FIG. 17 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### VARIATIONS

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

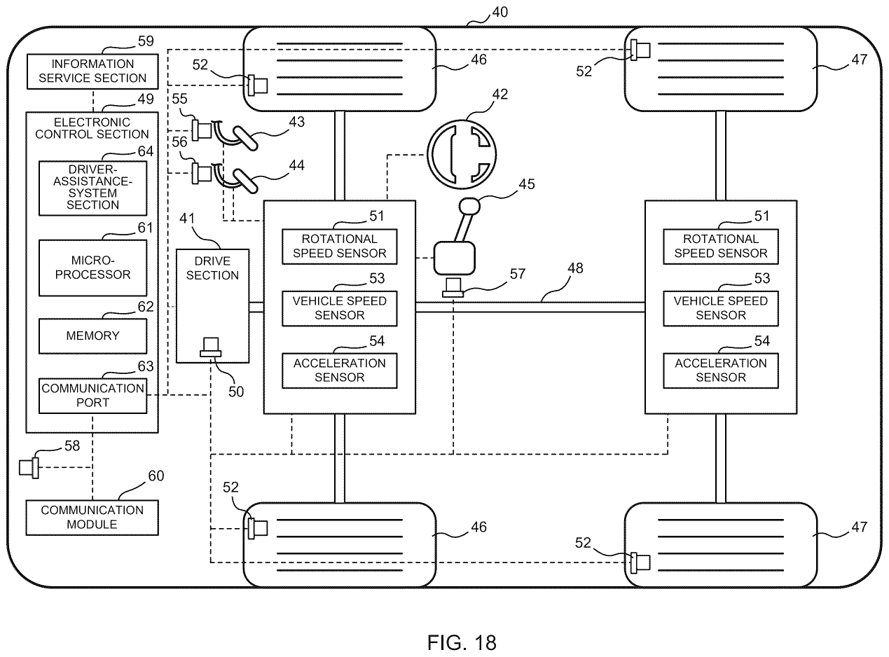

FIG. 18 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action.

“Decide/deciding (determine/determining)” may be used interchangeably with “assume/assuming”, “expect/expecting”, “consider/considering”, and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1. A terminal comprising:
a receiving section that receives a configuration of a channel state information (CSI) report including a property of a time domain or a Doppler domain; and
a control section that determines, based on the configuration, a number of CSI processing units used for processing of the CSI report and a CSI processing unit occupancy time for the processing and that controls the CSI report, based on the number of CSI processing units and the CSI processing unit occupancy time.

2. The terminal according to claim 1, wherein
the control section controls reporting of a capability related to at least one of a CSI reference signal (CSI-RS) resource and a port for the CSI report.

3. The terminal according to claim 1, wherein
the control section determines at least one of an active CSI-RS resource and an active port for the CSI report, and assumes that a number of at least one of the active CSI-RS resources and the active ports does not exceed a value reported as a capability.

4. The terminal according to claim 1, wherein
the control section determines duration for at least one of an active CSI-RS resource and an active port for the CSI report, and associates the duration with at least one of a CSI measurement window and a CSI reporting window.

5. A radio communication method for a terminal, the radio communication method comprising:
receiving a configuration of a channel state information (CSI) report including a property of a time domain or a Doppler domain; and
determining, based on the configuration, a number of CSI processing units used for processing of the CSI report and a CSI processing unit occupancy time for the processing and controlling the CSI report, based on the number of CSI processing units and the CSI processing unit occupancy time.

6. A base station comprising:
a transmitting section that transmits a configuration of a channel state information (CSI) report including a property of a time domain or a Doppler domain; and
a control section that determines, based on the configuration, a number of CSI processing units used for processing of the CSI report and a CSI processing unit occupancy time for the processing and that controls the CSI report, based on the number of CSI processing units and the CSI processing unit occupancy time.
